(19) United States
(12) Patent Application Publication
(10) Pub. No.: US 2026/0172763 A1
(43) Pub. Date: Jun. 18, 2026

(54) DEMONSTRATION SYSTEM FOR EAR-WEARABLE DEVICE FEATURES AND ACCESSORIES

(71) Applicant: Starkey Laboratories, Inc., Eden Prairie, MN (US)

(72) Inventors: Justin R. Burwinkel, Eden Prairie, MN (US); Eric George, Bloomington, MN (US); David Alan Fabry, Eden Prairie, MN (US)

(21) Appl. No.: 19/408,596

(22) Filed: Dec. 4, 2025

Related U.S. Application Data
(60) Provisional application No. 63/733,709, filed on Dec. 13, 2024.

(51) Int. Cl. H04R 25/00; G06F 3/16; H04R 1/08

(52) U.S. Cl. CPC H04R 25/50; G06F 3/165; H04R 1/08; H04R 25/554

(57) ABSTRACT

Embodiments herein relate to ear-wearable device systems. In an embodiment, a method executed in a processor of an ear-wearable device system for providing information related to a user of an ear-wearable device system, or a communication partner of the user. The ear-wearable device system can include an ear-wearable device, an accessory speaker outside of an ear-wearable device housing, and an accessory microphone, a speaker, an ear-wearable device microphone, and a memory storage. The method can include recording a first audio sample with the ear-wearable device microphone, wherein the first audio sample includes a first target stimuli. The method can include recording a second audio sample with the accessory microphone, wherein the second audio sample includes a second target stimuli. The method can include playing the first audio sample and the second audio sample at the accessory speaker or at the ear-wearable device speaker. Other embodiments are also included herein.

This application claims the benefit of U.S. Provisional Application No. 63/733,709, filed Dec. 13, 2024, the content of which is incorporated herein by reference in its entirety.

### FIELD

Embodiments herein relate to ear-wearable device systems and more particularly to systems and methods for optimally utilizing ear-wearable device systems.

### BACKGROUND

Modern ear-wearable devices include hearing aids, which are electronic instruments worn in or around the ear that compensate for hearing losses by producing or optionally amplifying sound. Ear-wearable devices typically include an enclosure or housing with one or more openings for a microphone that senses sound, hearing assistance device electronics including processing electronics, and a speaker or receiver to play sound for the wearer. Ear-wearable devices offer life changing benefits to individuals with hearing impairment. However, to receive the full benefits of ear-wearable devices, users can learn how to optimally use their devices and how to communicate optimally with communication partners.

### SUMMARY

In a first aspect, a method executed in a processor of an ear-wearable device system for providing information related to an ear-wearable device system, a user of an ear-wearable device system, or a communication partner of the user. The ear-wearable device system can further include an ear-wearable device, an accessory speaker outside of an ear-wearable device housing, and an accessory microphone, wherein the ear-wearable device includes an ear-wearable device speaker, an ear-wearable device microphone, and a memory storage. The method can include recording a first audio sample with the ear-wearable device microphone, wherein the first audio sample includes a first target stimuli. The method can include recording a second audio sample with the accessory microphone, wherein the second audio sample includes a second target stimuli. The method can include playing the first audio sample and the second audio sample at the accessory speaker or at the ear-wearable device speaker.

In a second aspect, in addition to one or more of the preceding or following aspects, or in the alternative to some aspects, the first audio sample and the second audio sample can be recorded simultaneously.

In a third aspect, in addition to one or more of the preceding or following aspects, or in the alternative to some aspects, the first target stimuli and the second target stimuli can be the same stimuli.

In a fourth aspect, in addition to one or more of the preceding or following aspects, or in the alternative to some aspects, the method can further include synchronizing the first audio sample and the second audio sample to create a composite audio sample, and playing the first audio sample and the composite audio sample at the accessory speaker or at the ear-wearable device speaker.

In a fifth aspect, in addition to one or more of the preceding or following aspects, or in the alternative to some aspects, the method can further include prompting a user input selection of the first audio sample or the second audio sample, wherein the user input selection indicates the audio sample in which the target stimuli can be most understandable to the user.

In a sixth aspect, in addition to one or more of the preceding or following aspects, or in the alternative to some aspects, the accessory microphone can be at a first location during the recording of the second audio sample, the method can further include: recording a third audio sample with the accessory microphone at a second location different from the first location, wherein the third audio sample includes a third target stimuli, and playing the third audio sample at the accessory speaker or at the ear-wearable device speaker, and prompting a user input selection the first audio sample, the second audio sample, or the third audio sample, wherein the user input selection indicates the audio sample in which the target stimuli can be most understandable.

In a seventh aspect, in addition to one or more of the preceding or following aspects, or in the alternative to some aspects, the accessory microphone can be facing a first direction during the recording of the second audio sample, the method can further include: recording a third audio sample with the accessory microphone facing a second direction different from the first direction, wherein the third audio sample includes a third target stimuli, and playing the third audio sample at the accessory speaker or at the ear-wearable device speaker, and prompting a user input selection the first audio sample, the second audio sample, or the third audio sample, wherein the user input selection indicates the audio sample in which the target stimuli can be most understandable.

In an eighth aspect, in addition to one or more of the preceding or following aspects, or in the alternative to some aspects, the method can further include generating an extraneous sound originating at a second location during the recording of the audio samples.

In a ninth aspect, in addition to one or more of the preceding or following aspects, or in the alternative to some aspects, the accessory microphone can be at a first location during the recording of the second audio sample, the method can further include: recording a third audio sample with the accessory microphone at a third location different from the first location, wherein the third location can be further away from the second location than the first location, and wherein the third audio sample includes a third target stimuli, and playing the third audio sample at the accessory speaker or at the ear-wearable device speaker, and prompting a user input selection the first audio sample, the second audio sample, or the third audio sample, wherein the user input selection indicates the audio sample in which the target stimuli can be most understandable.

In a tenth aspect, in addition to one or more of the preceding or following aspects, or in the alternative to some aspects, the accessory microphone can be using a first set of processing parameters during the recording of the second audio sample, the method can further include: recording a third audio sample with the accessory microphone using a second set of processing parameters different from the first set of processing parameters, wherein the third audio sample includes a third target stimuli, and playing the third audio sample at the accessory speaker or at the ear-wearable device speaker, and prompting a user input selection of the first audio sample, the second audio sample, or the third audio sample, wherein the user input selection indicates the audio sample in which the target stimuli can be most understandable.

In an eleventh aspect, in addition to one or more of the preceding or following aspects, or in the alternative to some aspects, the ear-wearable device system further includes a display device configured to display a visual representation of the first audio sample and the second audio sample.

In a twelfth aspect, in addition to one or more of the preceding or following aspects, or in the alternative to some aspects, the method can further include prompting a user input selection of the first audio sample or the second audio sample, wherein the user input selection indicates the audio sample in which the target stimuli can be most understandable on the display device.

In a thirteenth aspect, in addition to one or more of the preceding or following aspects, or in the alternative to some aspects, the first target stimuli and the second target stimuli can include voice signals, the method can further include prompting a user input selection of the first audio sample or the second audio sample, wherein the user input selection indicates the audio sample in which the voice signals can be most understandable.

In a fourteenth aspect, in addition to one or more of the preceding or following aspects, or in the alternative to some aspects, the ear-wearable device microphone can be a directional microphone configured to have a beam in front of the user and null being at an angle relative to the front of the user when the ear-wearable device can be worn by the user.

In a fifteenth aspect, in addition to one or more of the preceding or following aspects, or in the alternative to some aspects, the accessory microphone can include an array of microphones.

In a sixteenth aspect, a method executed in a processor of an ear-wearable device system for providing information related to an ear-wearable device system, a user of an ear-wearable device system, or a communication partner of the user. The ear-wearable device system can further include an ear-wearable device, an accessory speaker outside of an ear-wearable device housing, and an accessory microphone, wherein the ear-wearable device includes an ear-wearable device speaker, an ear-wearable device microphone, and a memory storage. The method can include recording a first audio sample with the ear-wearable device microphone, wherein the first audio sample includes a first target stimuli. The method can include recording a second audio sample with both the accessory microphone and the ear-wearable device microphone, wherein the second audio sample includes a second target stimuli. The method can include synchronizing the second audio sample recorded with the accessory microphone with the second audio sample recorded with the ear-wearable device microphone to create a composite audio sample. The method can include playing the first audio sample and the composite audio sample at the accessory speaker or at the ear-wearable device speaker.

In a seventeenth aspect, in addition to one or more of the preceding or following aspects, or in the alternative to some aspects, the method can further include prompting a user input selection of the first audio sample or the composite audio sample, wherein the user input selection indicates the audio sample in which the target stimuli can be most understandable.

In an eighteenth aspect, in addition to one or more of the preceding or following aspects, or in the alternative to some aspects, the ear-wearable device system further includes a display device configured to display a visual representation of the first audio sample and the composite audio sample.

In a nineteenth aspect, in addition to one or more of the preceding or following aspects, or in the alternative to some aspects, the method can further include prompting a user input selection of the first audio sample or the composite audio sample, wherein the user input selection indicates the audio sample in which the target stimuli can be most understandable on the display device.

In a twentieth aspect, in addition to one or more of the preceding or following aspects, or in the alternative to some aspects, the first target stimuli and the second target stimuli can include voice signals, the method can further include prompting a user input selection of the first audio sample or the composite audio sample, wherein the user input selection indicates the audio sample in which the voice signals can be most understandable.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

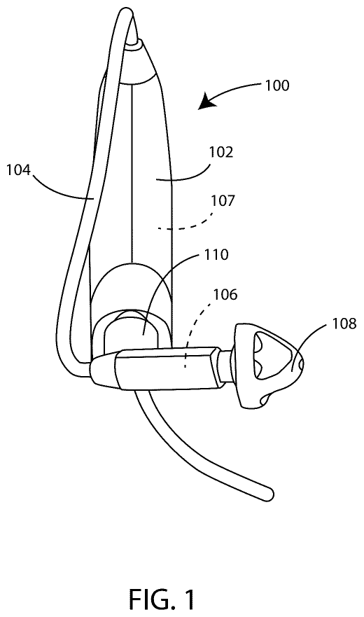

Referring now to FIG. 1, a schematic view of an ear-wearable device is shown in accordance with various embodiments herein.

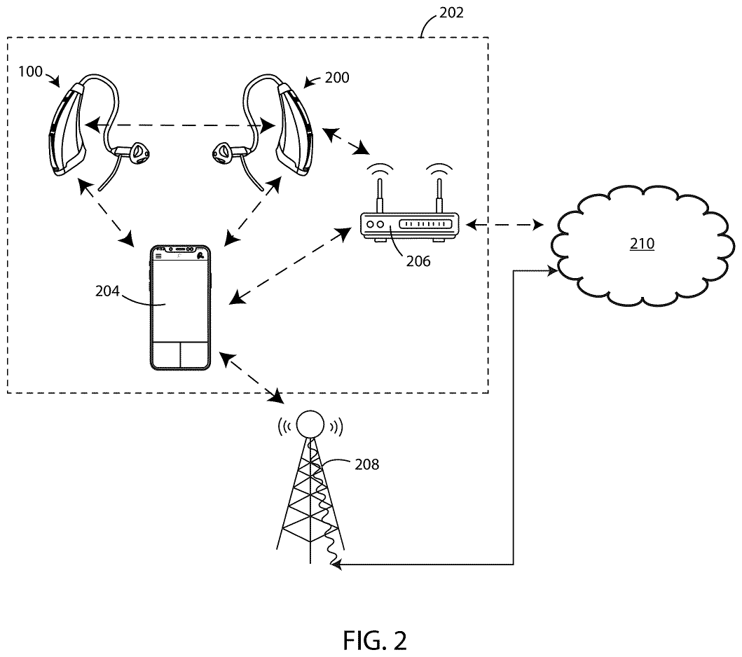

Referring now to FIG. 2, a schematic view of components of an ear-wearable device system is shown in accordance with various embodiments herein.

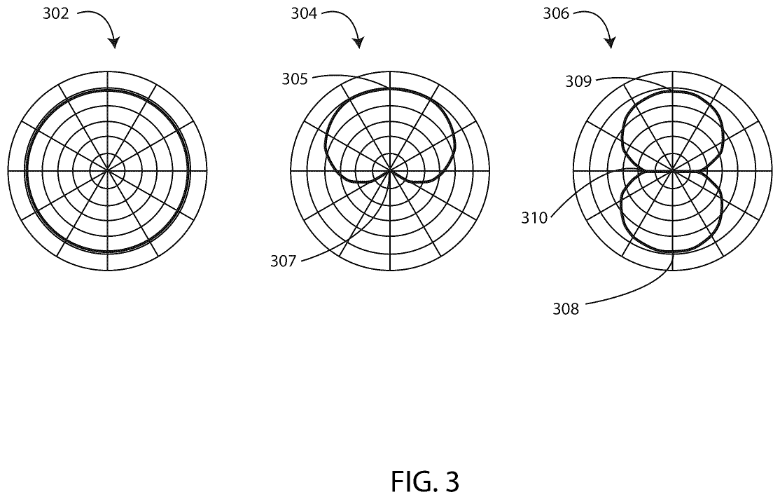

Referring now to FIG. 3, polar patterns for an omnidirectional microphone, a unidirectional microphone, and a bidirectional microphone are shown in accordance with various embodiments herein.

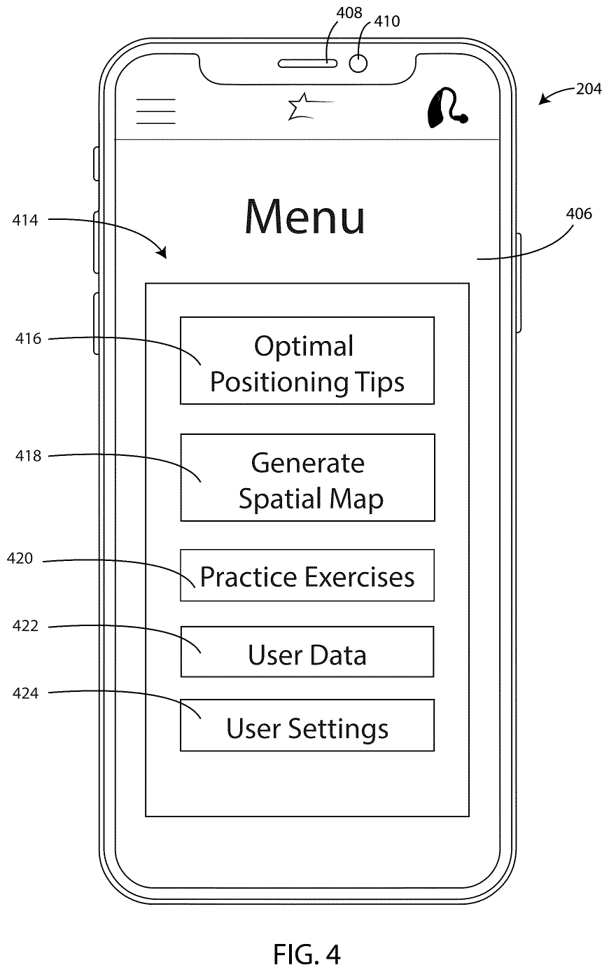

Referring now to FIG. 4, a schematic view of an accessory device including a user interface for rendering a main menu is shown in accordance with various embodiments herein.

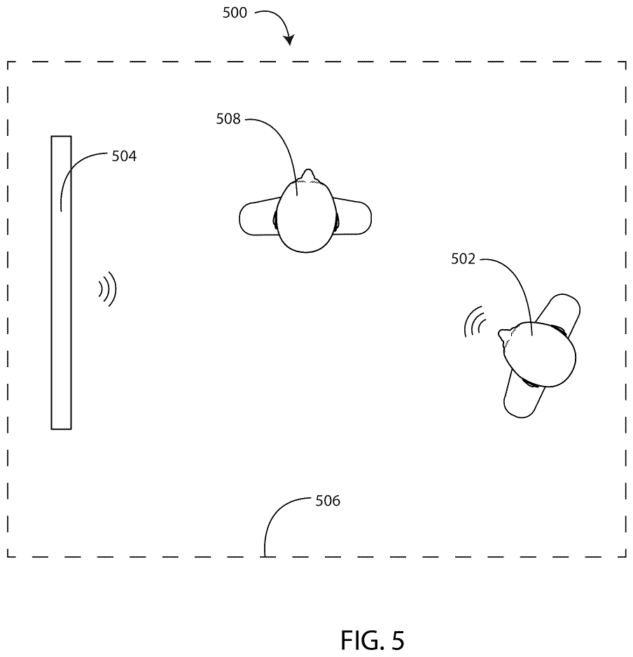

Referring now to FIG. 5, a schematic view of an acoustic environment is shown in accordance with various embodiments herein.

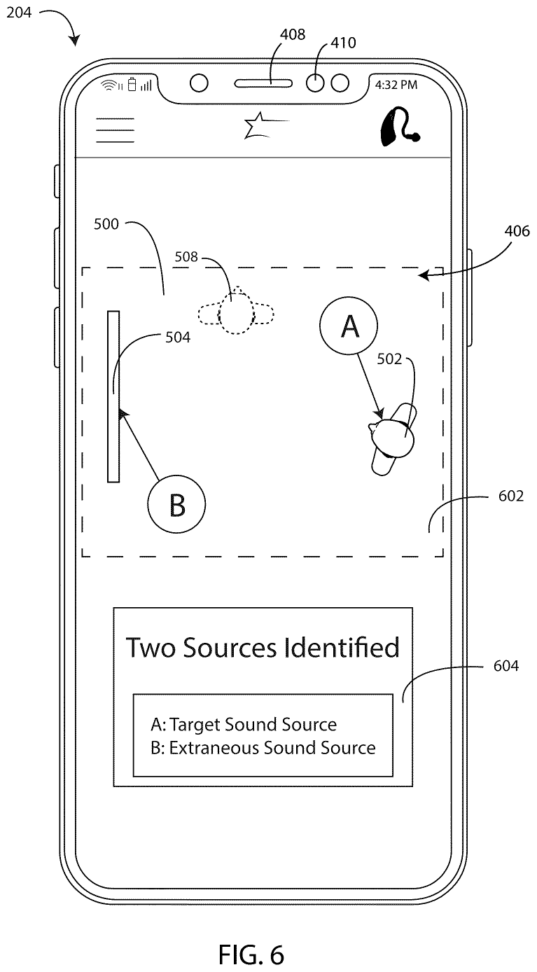

Referring now to FIG. 6, a schematic view of an accessory device including a user interface for rendering a visual representation of sound sources in an acoustic environment is shown in accordance with various embodiments herein.

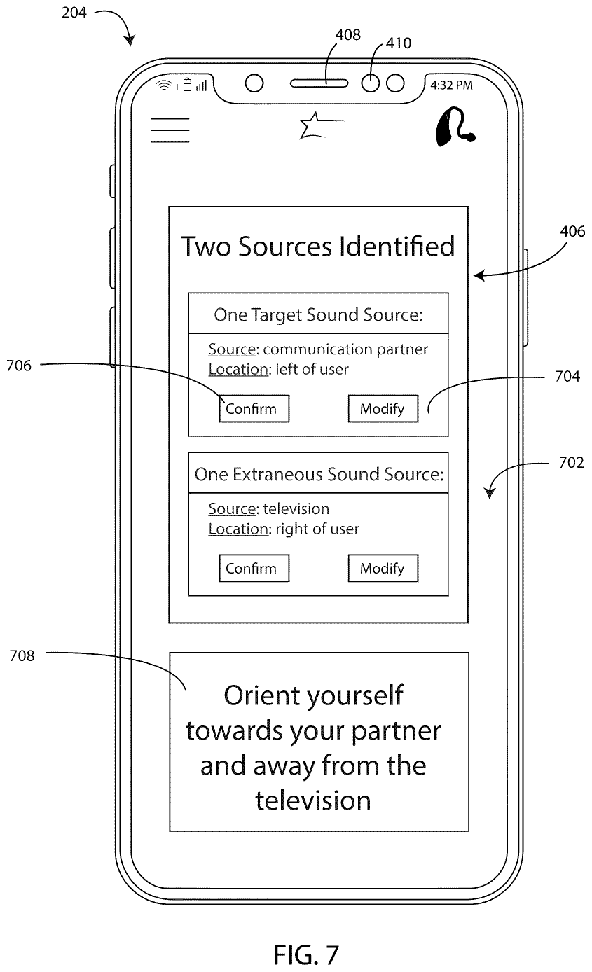

Referring now to FIG. 7, a schematic view of an accessory device including a user interface for rendering a visual representation of sound sources in an acoustic environment is shown in accordance with various embodiments herein.

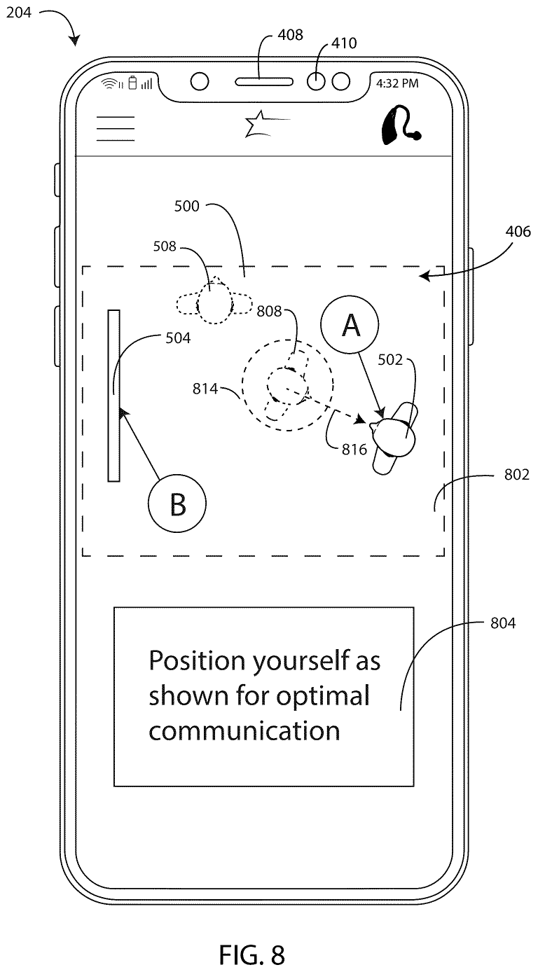

Referring now to FIG. 8, a schematic view of an accessory device including a user interface for rendering a visual representation of sound sources in an acoustic environment is shown in accordance with various embodiments herein.

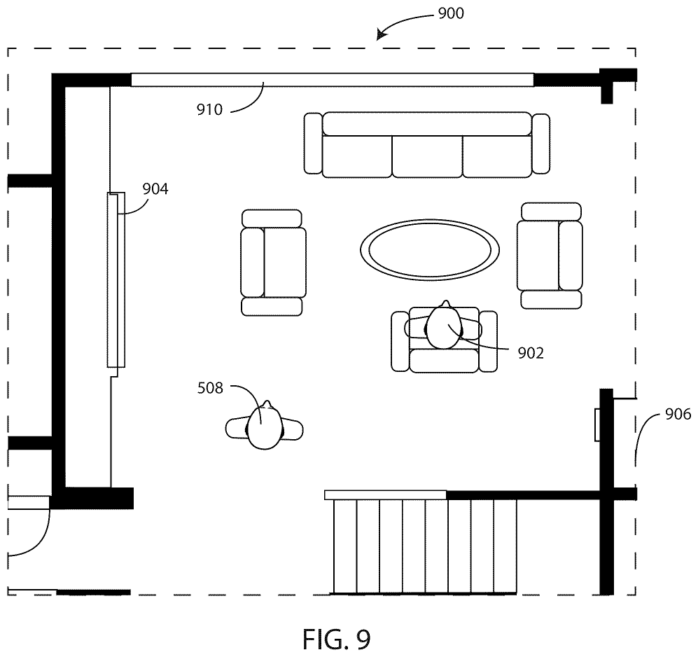

Referring now to FIG. 9, a schematic view of an acoustic environment is shown in accordance with various embodiments herein.

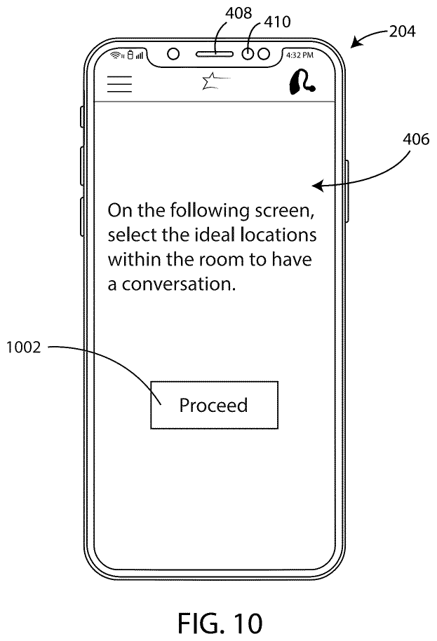

Referring now to FIG. 10, a schematic view of an accessory device including a user interface for rendering a prompt is shown in accordance with various embodiments herein.

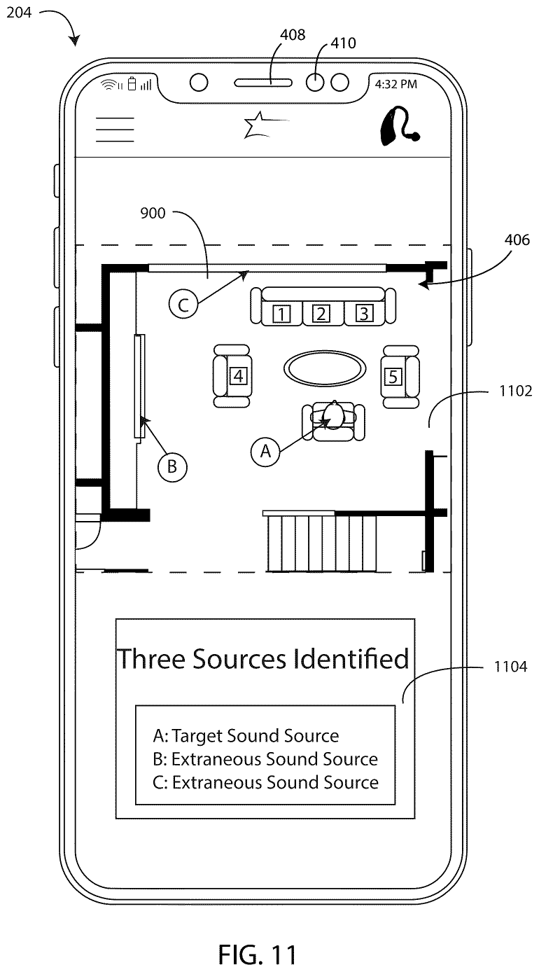

Referring now to FIG. 11, a schematic view of an accessory device including a user interface for rendering a visual representation of sound sources in an acoustic environment is shown in accordance with various embodiments herein.

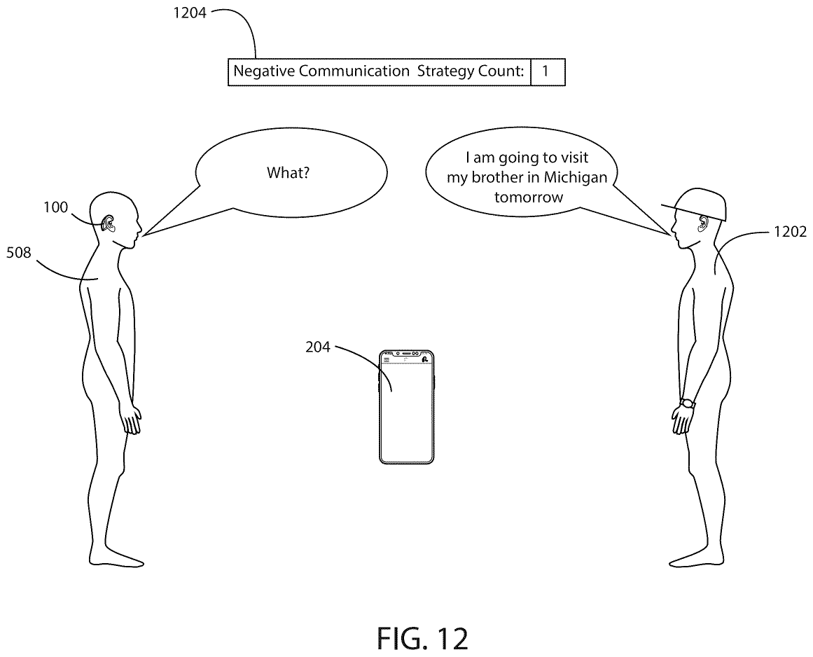

Referring now to FIG. 12, an example scenario of poor communication between an ear-wearable device user and their communication partner is shown in accordance with various embodiments herein.

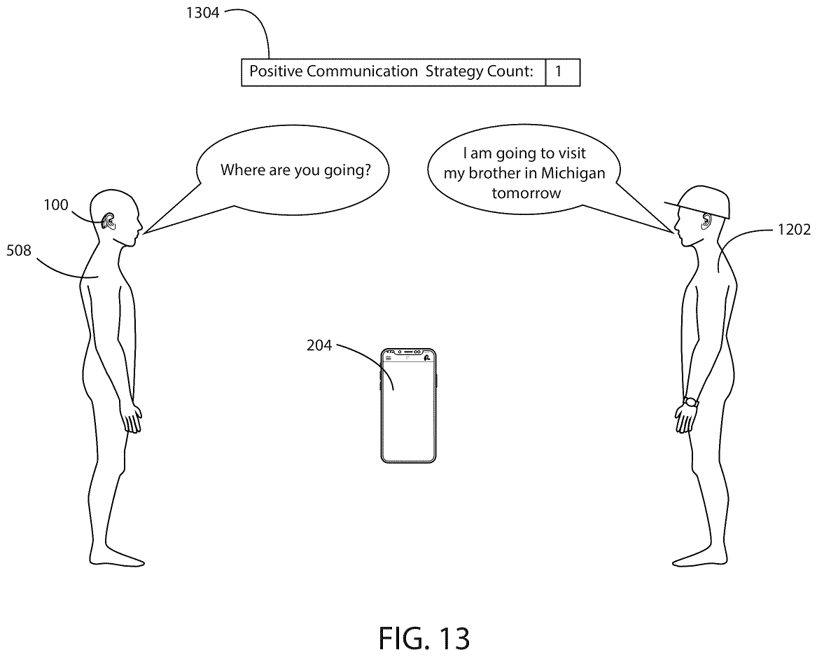

Referring now to FIG. 13, an example scenario of good communication between an ear-wearable device user and their communication partner is shown in accordance with various embodiments herein.

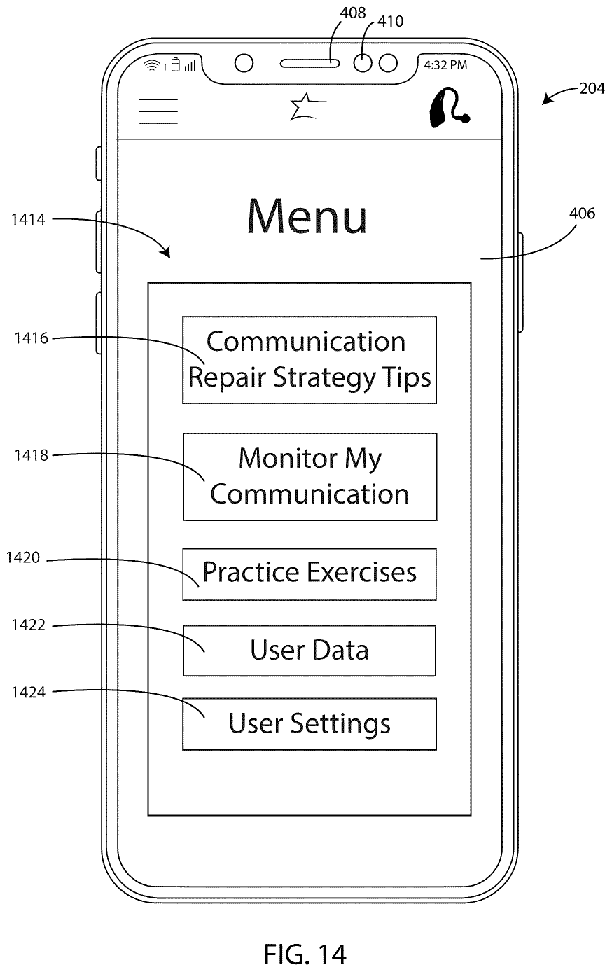

Referring now to FIG. 14, a schematic view of an accessory device including a user interface for rendering a main menu is shown in accordance with various embodiments herein.

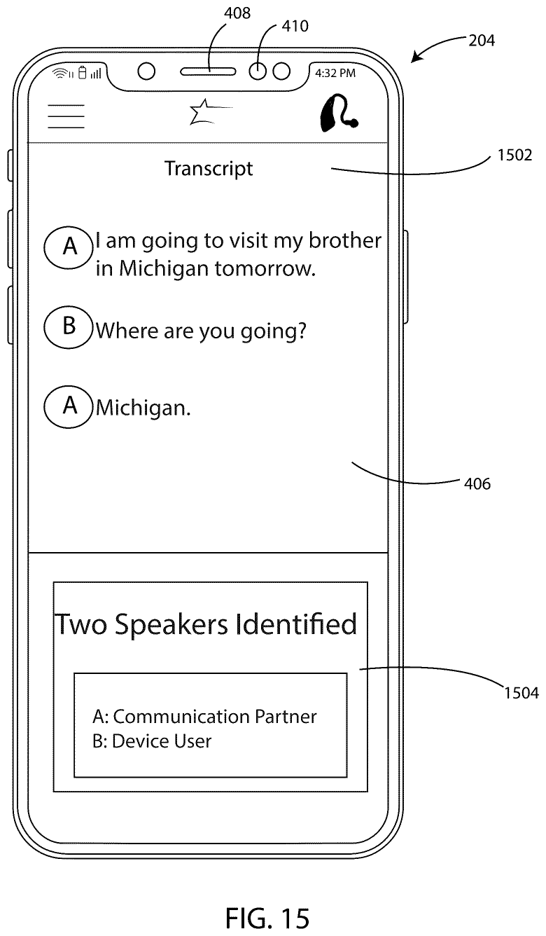

Referring now to FIG. 15, a schematic view of an accessory device including a user interface for rendering a transcript is shown in accordance with various embodiments herein.

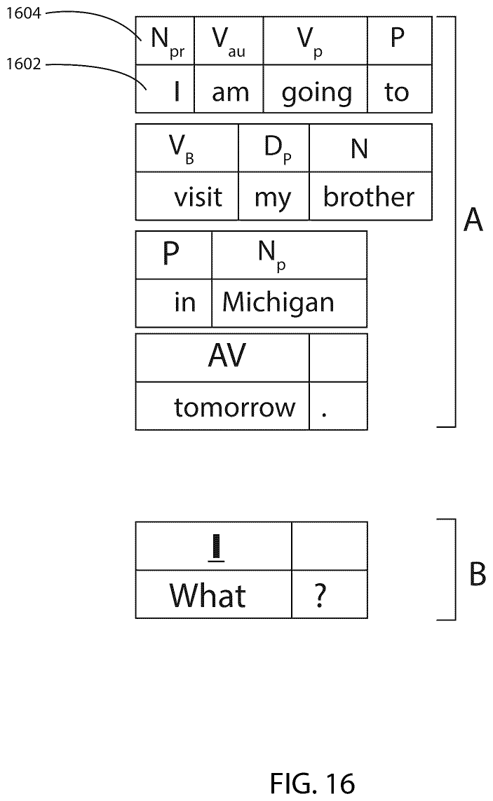

Referring now to FIG. 16, a schematic view of a portion of a voice output transformed into a text-based transcript by the ear-wearable device system is shown in accordance with various embodiments herein.

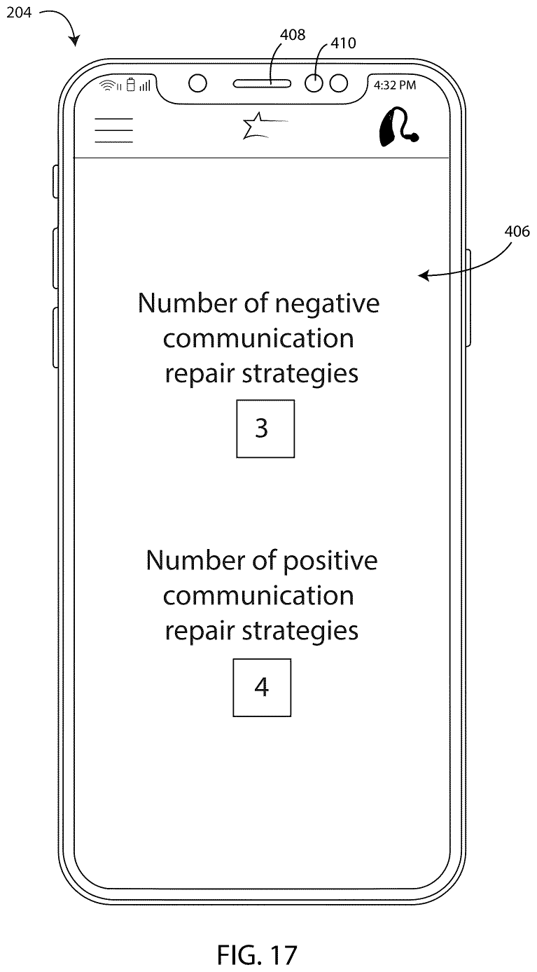

Referring now to FIG. 17, a schematic view of an accessory device including a user interface for rendering feedback regarding communication strategies is shown in accordance with various embodiments herein.

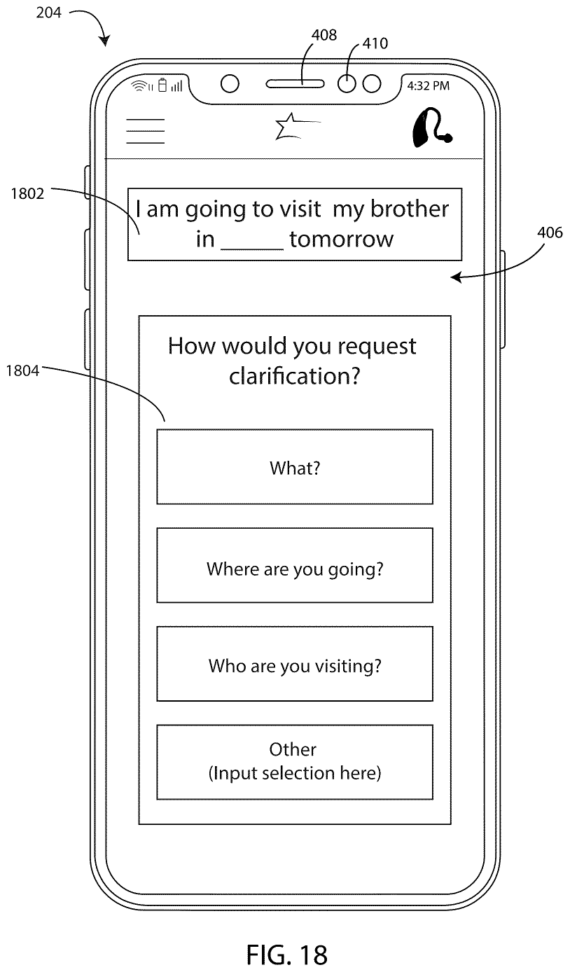

Referring now to FIG. 18, a schematic view of an accessory device including a user interface for rendering a communication repair strategy simulation is shown in accordance with various embodiments herein.

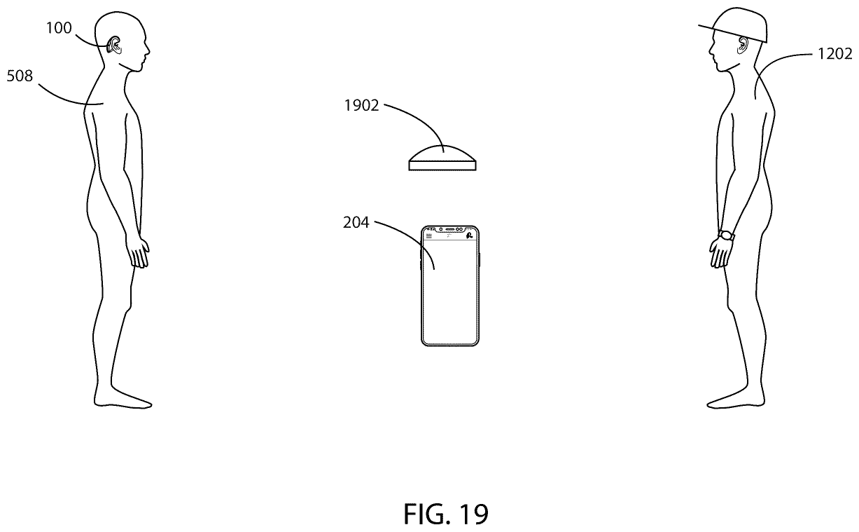

Referring now to FIG. 19, a schematic view of an ear-wearable device user and communication partner utilizing an ear-wearable device system is shown in accordance with various embodiments herein.

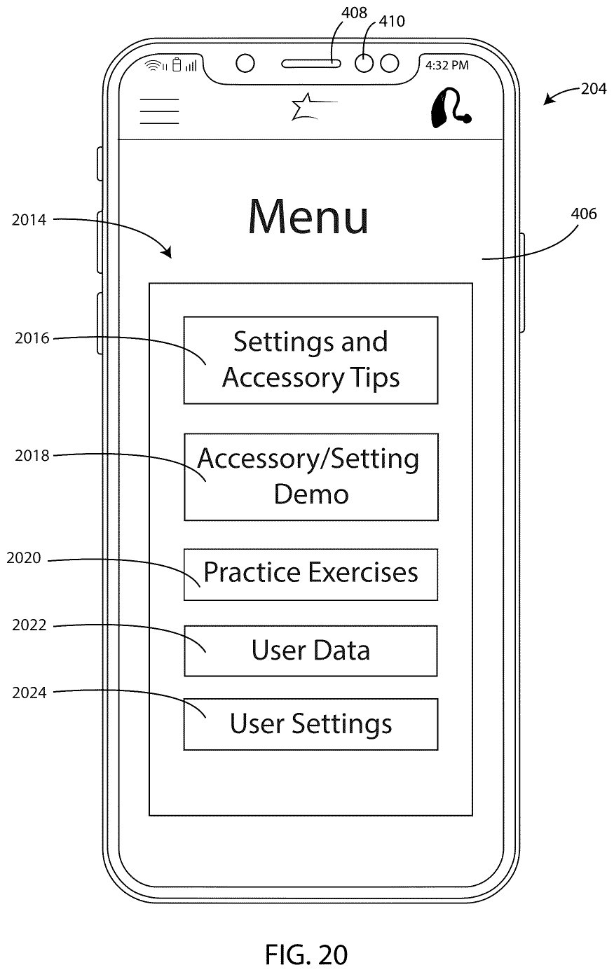

Referring now to FIG. 20, a schematic view of an accessory device including a user interface for rendering a main menu is shown in accordance with various embodiments herein.

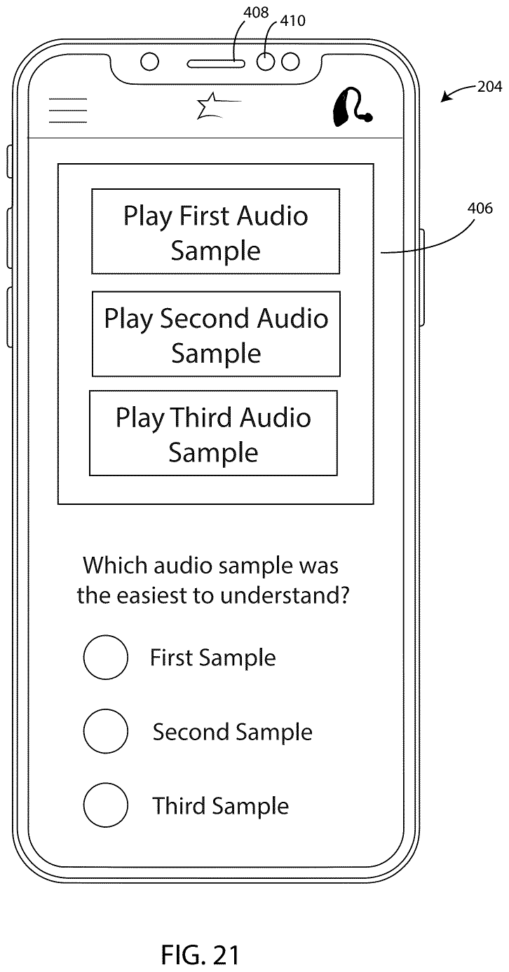

Referring now to FIG. 21, a schematic view of an accessory device including a user interface for rendering a selection of audio samples is shown in accordance with various embodiments herein.

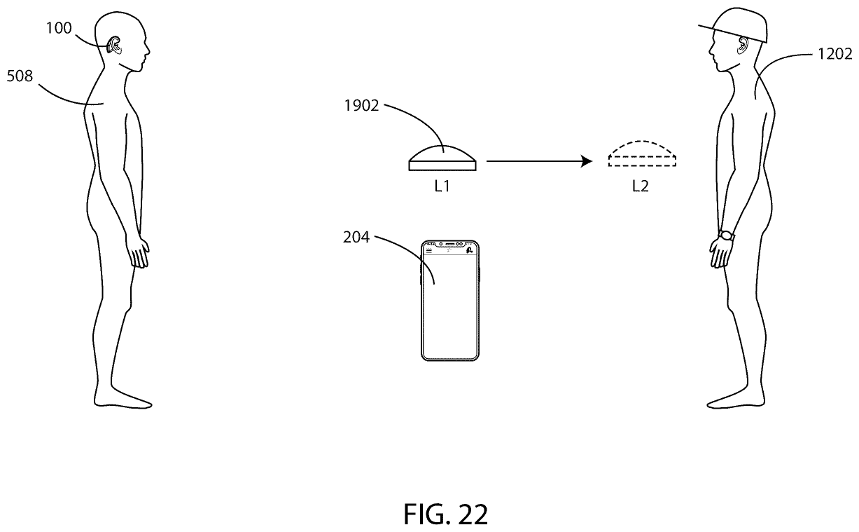

Referring now to FIG. 22, a schematic view of an ear-wearable device user and communication partner utilizing an ear-wearable device system is shown in accordance with various embodiments herein.

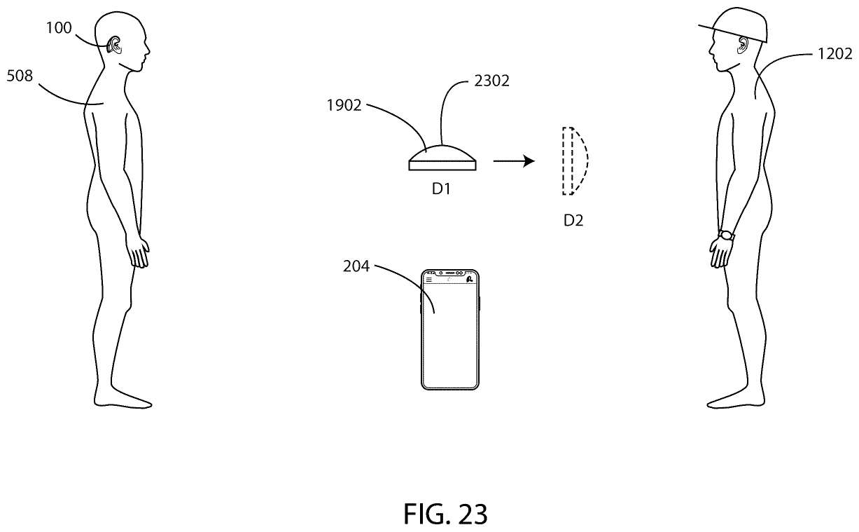

Referring now to FIG. 23, a schematic view of an ear-wearable device user and communication partner utilizing an ear-wearable device system is shown in accordance with various embodiments herein.

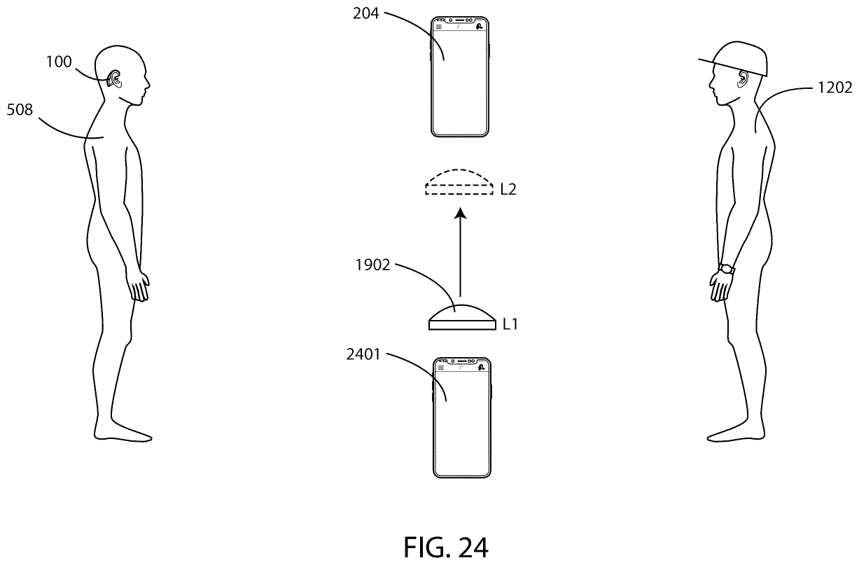

Referring now to FIG. 24, a schematic view of an ear-wearable device user and communication partner utilizing an ear-wearable device system is shown in accordance with various embodiments herein.

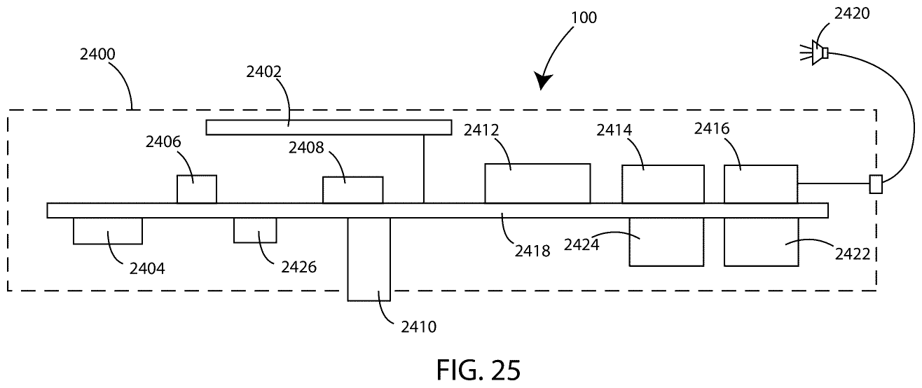

Referring now to FIG. 25, a schematic block diagram of components of an ear-wearable device is shown in accordance with various embodiments herein is shown in accordance with various embodiments herein.

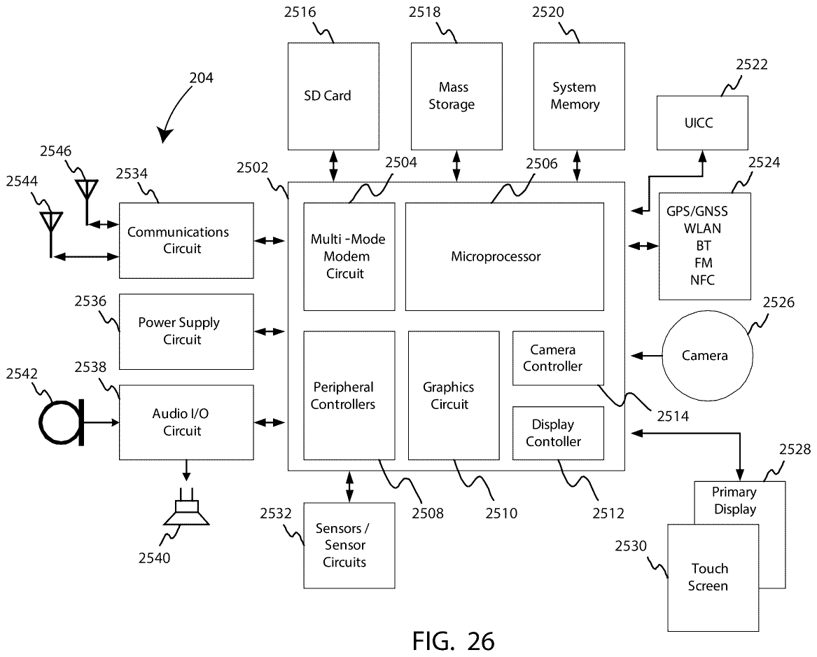

Referring now to FIG. 26, a schematic block diagram of components of an accessory device is shown in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

A system and method of providing guidance to an ear-wearable device user and/or their communication partner can be provided. Such a method can be executed in a processor of an ear-wearable device system. In various embodiments, the ear-wearable device system can include a speaker, a memory storage, and ear-wearable device configured to be worn by the user. The ear-wearable device can include a microphone. The ear-wearable device system can further include an accessory speaker outside of an ear-wearable device housing, and an accessory microphone.

In various embodiments, the method can include receiving input audio from a surrounding environment over a period of time with the microphone. In various embodiments, the method can include creating a spatial map of sound sources in the surrounding environment relative to the first microphone based on the input audio. In various embodiments, the method can include generating a prompt to the user of the ear-wearable device to position themselves relative to the sound sources. In various embodiments, the method can be performed at any suitable time or location by the ear-wearable device user and/or their commination partner without the need for expert intervention.

In various embodiments, the method can include monitoring a voice output of the user with the microphone. In various embodiments, the method can include processing the voice output of the user by at least one of counting a first number of instances in which the user implements a positive communication repair strategy and counting a second number of instances in which the user implements a negative communication repair strategy. In various embodiments, the method can include generating feedback indicative of the first number of instances, the second number of instances, or both the first number of instances and the second number of instances.

In various embodiments, the method can include recording a first audio sample with the ear-wearable device microphone. The first audio sample can include a first target stimuli. In various embodiments, the method can include recording a second audio sample with the accessory microphone. The second audio sample can include a second target stimuli. In various embodiments, the method can include playing the first audio sample and the second audio sample at the accessory speaker or at the ear-wearable device speaker.

### Ear-Wearable Device (FIG. 1)

Referring now to FIG. 1, a schematic view of an ear-wearable device 100 is shown in accordance with various embodiments herein. The ear-wearable device 100 can include an ear-wearable device housing 102. The ear-wearable device housing 102 can define a battery compartment 110 into which a battery can be disposed to provide power to the device.

The ear-wearable device 100 can also include a receiver 106 adjacent to an earbud 108. The receiver 106 can include a component that converts electrical impulses into sound, such as an electroacoustic transducer, speaker, or loudspeaker. Such components can be used to generate an audible stimulus in various embodiments herein. A cable 104 or connecting wire can include one or more electrical conductors and provide electrical communication between components inside of the ear-wearable device housing 102 and components inside of the receiver 106. The ear-wearable device housing 102 can include one or more microphones 107 configured to receive an acoustic input from the surrounding environment and to transmit the acoustic input to the receiver via the cable 104.

The ear-wearable device 100 shown in FIG. 1 is a receiver-in-canal type device and thus the receiver is designed to be placed within the ear canal. However, it will be appreciated that many different form factors for ear-wearable devices are contemplated herein. As such, ear-wearable devices herein can include, but are not limited to, behind-the-ear (BTE), in-the ear (ITE), in-the-canal (ITC), invisible-in-canal (IIC), receiver-in-canal (RIC), receiver in-the-ear (RITE) and completely-in-the-canal (CIC) type hearing assistance devices. Additionally, the devices may include configurations such as Contralateral Routing of Signals (CROS) and Bilateral Contralateral Routing of Signals (BiCROS) systems. CROS devices are designed to transmit sound from the ear with poorer hearing to the ear with better hearing, enhancing sound awareness in cases of unilateral hearing loss. BiCROS devices perform a similar function but are optimized for users with hearing loss in both ears, combining the routing of sound from the poorer ear with amplification in the ear with better hearing to improve overall hearing performance.

The term “ear-wearable device” shall also refer to devices that can produce optimized or processed sound for persons with normal hearing. Ear-wearable devices herein can include hearing assistance devices. In some embodiments, the ear-wearable device can be a hearing aid falling under 21 C.F.R. § 801.420. In another example, the ear-wearable device can include one or more Personal Sound Amplification Products (PSAPs). In another example, the ear-wearable device can include one or more cochlear implants, cochlear implant magnets, cochlear implant transducers, and cochlear implant processors. In another example, the ear-wearable device can include one or more “hearable” devices that provide various types of functionality. In other examples, ear-wearable devices can include other types of devices that are wearable in, on, or in the vicinity of the user's ears, such as glasses or the like. In other examples, ear-wearable devices can include other types of devices that are implanted or otherwise integrated with the user's skull; wherein the device is able to facilitate stimulation of the wearer's ears via the bone conduction pathway.

Ear-wearable devices of the present disclosure can incorporate an antenna arrangement coupled to a radio, such as a 2.4 GHz radio. The radio can conform to an IEEE 802.11 (e.g., WIFI®) or BLUETOOTH®(e.g., BLE, BLUETOOTH®4.2 or 5.2) specification, for example. It is understood that ear-wearable devices of the present disclosure can employ other radios, such as a 900 MHz radio. Ear-wearable devices of the present disclosure can also include hardware, such as one or more antennas, for NFMI or NFC wireless communications. Ear-wearable devices of the present disclosure can be configured to receive streaming audio (e.g., digital audio data or files) from an electronic or digital source. Representative electronic/digital sources (also referred to herein as accessory devices) include an assistive listening system, a TV streamer, a radio, a smartphone, a cell phone/entertainment device (CPED) or other electronic device that serves as a source of digital audio data or files.

While FIG. 1 shows a single hearing assistance device, it will be appreciated that subjects can utilize two hearing assistance devices, such as one for each ear. In such cases, the hearing assistance devices and sensors therein can be disposed on opposing lateral sides of the subject's head. It should be appreciated that the subject's head can cause a head shadow effect to occur. The head shadow effect refers to the attenuation and modification of sound waves as they travel around the head, notably impacting the sound arriving at the ear-wearable device worn on the side opposite the target sound source. This effect is frequency-dependent, with higher frequencies experiencing greater attenuation due to their shorter wavelengths, which cannot effectively diffract around the subject's head. Sounds above approximately 1500 Hz are particularly affected, resulting in reduced intensity and high-frequency content at the ear farther from the source. Lower frequencies, with longer wavelengths, diffract more easily, leading to less pronounced attenuation. Additionally, slight timing differences arise because sound must travel a longer path to reach the ear on the shadowed side, causing interaural time delays.

### Ear-Wearable Device System (FIG. 2)

Referring now to FIG. 2, a schematic view of components of an ear-wearable device system is shown in accordance with various embodiments herein. FIG. 2 shows an ear-wearable device 100 and a second ear-wearable device 200. FIG. 2 also shows an accessory device 204. In various embodiments, signals and/or data can be exchanged between the ear-wearable device 100 and the second ear-wearable device 200.

A user wearing an ear-wearable device 100 may also have an accessory device 204. The accessory device may also be referred to as a gateway device, and may have access to network resources, such as a cellular network or another wide area network. The accessory device 204 can be configured to communicate wirelessly with the ear-wearable device 100. Examples of an accessory device include a smart phone, computer tablet, or laptop computer, cellular telephone, personal digital assistant, personal computer, streaming device, wide area network device, personal area network device, remote microphone, smart watch, home monitoring device, internet gateway, hearing device programmer, smart glasses, a captioning device, remote microphone, smart watch, home monitoring device, internet gateway, hearing aid accessory, TV streamer, wireless audio streaming device, landline streamer, remote control, Direct Audio Input (DAI) gateway, audio gateway, telecoil receiver, hearing device programmer, charger, drying box, smart glasses, a wearable or implantable health monitor, and combinations thereof, or the like. In various embodiments, the ear-wearable device system can include one, two, three, four, or more accessory devices configured to communicate with the ear-wearable device.

The ear-wearable device 100 is worn in a fixed position relative to the user's head. Consequentially, at most times it is easily accessible to the user. It is also possible for the user to have or wear an accessory device, such as a smart watch. Some accessory devices can be worn so that they are fixed in relation to the user's body, such as a smart watch or smart glasses. A fixed relationship to the user's body allows the accessory device to be easily accessible to the user. The fixed relationship also enables the accessory device to include a sensor that can gather sensor data about the user and the user's movement.

It will be appreciated that data and/or signals can be exchanged between many different components in accordance with embodiments herein. In a first location 202, a subject (not shown) can have a first ear-wearable device 100 and a second ear-wearable device 200. Each of the ear-wearable devices 100, 200 can include sensor packages as described herein including, for example, a motion sensor. The sensor package can comprise one or a multiplicity of sensors. In some embodiments, the sensor packages can include one or more motion sensors amongst other types of sensors. Motion sensors herein can include inertial measurement units (IMU), accelerometers, gyroscopes, barometers, altimeters, and the like. Motions sensors can be used to track movement of a subject in accordance with various embodiments herein.

In some embodiments, an inertial measurement unit (IMU) is present in an ear-wearable device. In some embodiments, an IMU is present in each of two ear-wearable devices that are worn together by a user. In some embodiments, the motion sensors can be disposed in a fixed position with respect to the head of a subject, such as worn on or near the head or ears. In some embodiments, the motion sensors can be disposed associated with another part of the body such as on a wrist, arm, or leg of the subject.

The ear-wearable devices 100, 200 and sensors therein can be disposed on opposing lateral sides of the subject's head. The ear-wearable devices 100, 200 and sensors therein can be disposed in a fixed position relative to the subject's head. The ear-wearable devices 100, 200 and sensors therein can be disposed within opposing ear canals of the subject. The ear-wearable devices 100, 200 and sensors therein can be disposed on or in opposing ears of the subject. The ear-wearable devices 100, 200 and sensors therein can be spaced apart from one another by a distance of at least 3, 4, 5, 6, 8, 10, 12, 14, or 16 centimeters and less than 40, 30, 28, 26, 24, 22, 20 or 18 centimeters, or by a distance falling within a range between any of the foregoing. In various embodiments, the fixed relationship of the ear-wearable devices with respect to each other, and corresponding sensors they contain, can permit triangulation of external sound sources and voice signals. In some embodiments, the disparities in intensity, frequency content, and timing caused by the head shadow effect can be detected and analyzed by the ear-wearable device system to localize the source of external sounds and voice signals.

In various embodiments, data and/or signals can be exchanged directly between the first ear-wearable device 100 and the second ear-wearable device 200. Data and/or signals can be exchanged wirelessly using various techniques including inductive techniques (such as near-field magnetic induction—NFMI), 900 MHz communications, 2.4 GHz communications, communications at another frequency, FM, AM, SSB, BLUETOOTH™, Low Energy BLUETOOTH™, Long Range BLUETOOTH™, IEEE 202.11(wireless LANs) Wi-Fi, 202.15(WPANs), 202.16(WiMAX), 202.20, and cellular protocols including, but not limited to CDMA and GSM, ZigBee, and ultra-wideband (UWB) technologies. Such protocols support radio frequency communications and some support infrared communications. It is possible that other forms of wireless communications can be used such as ultrasonic, optical, and others. It is understood that the standards which can be used include past and present standards. It is also contemplated that future versions of these standards and new future standards may be employed without departing from the scope of the present subject matter.

An accessory device 204 such as a smart phone, smart watch, internet gateway, or the like, can also be disposed within the first location 202. The accessory device 204 can exchange data and/or signals with one or both of the first ear-wearable device 100 and the second ear-wearable device 200 and/or with an accessory to the ear-wearable devices (e.g., a remote microphone, a remote control, a phone streamer, etc.).

Data and/or signals can be exchanged between the accessory device 204 and one or both of the ear-wearable devices (as well as from an accessory device to another location or device) using various techniques including, but not limited to inductive techniques (such as near-field magnetic induction—NFMI), 900 MHz communications, 2.4 GHz communications, communications at another frequency, FM, AM, SSB, BLUETOOTH™, Low Energy BLUETOOTH™, Long Range BLUETOOTH™, IEEE 202.11(wireless LANs) Wi-Fi, 202.15(WPANs), 202.16(WiMAX), 202.20, and cellular protocols including, but not limited to CDMA and GSM, ZigBee, and ultra-wideband (UWB) technologies. Such protocols support radio frequency communications and some support infrared communications. It is possible that other forms of wireless communications can be used such as ultrasonic, optical, and others. It is also possible that forms of wireless mesh networks may be utilized to support communications between various devices, including devices worn by other individuals. It is understood that the standards which can be used include past and present standards. It is also contemplated that future versions of these standards and new future standards may be employed without departing from the scope of the present subject matter.

The accessory device 204 can also exchange data across a data network to the cloud 210, such as through a wireless signal connecting with a local accessory device, such as over a mesh network, such as a network router 206 or through a wireless signal connecting with a cell tower 208 or similar communications tower. In some embodiments, the accessory device can also connect to a data network to provide communication to the cloud 210 through a direct wired connection.

### Microphone Configurations (FIG. 3)

Referring now to FIG. 3, polar patterns for an omnidirectional microphone, a unidirectional microphone, and a bidirectional microphone are shown in accordance with various embodiments herein. A polar pattern as shown herein is configured to describe how a microphone picks up sound from different directions around it. In various embodiments, ear-wearable devices can include one or more microphones (e.g., microphone 107) that are configured to gather acoustic energy (sound) from the surrounding environment and convert the acoustic energy into electrical signals.

In various embodiments, the ear-wearable device 100 can include one or more omnidirectional microphones. Polar pattern 302 depicts a polar pattern for an omnidirectional microphone. Omnidirectional microphones are designed to pick up sound equally from all directions. Accordingly, whether a sound originates from in front of the user, behind, or from the sides, an omnidirectional microphone will capture it with the same sensitivity. Omnidirectional microphones are particularly useful in quiet environments or situations where the listener wants to be aware of everything happening around them. For example, in a setting where ambient noise levels are low and the user desires to engage in conversation with multiple people seated around a table, an omnidirectional setting would be beneficial. However, in certain scenarios, omnidirectional microphones tend to have a worse signal to noise ratio relative to other types of microphones.

In various embodiments, the ear-wearable device 100 can include one or more directional microphones. Directional microphones are designed to focus on sound coming from a specific direction while reducing the pickup of sounds from other directions. For instance, directional microphones can have beam(s) facing desired direction(s) and null(s) facing undesired direction(s). Such a configuration can be useful in noisy environments where the listener wants to focus on a specific sound source such as a conversation partner in a crowded restaurant. Directional microphones can be either fixed directional (the beam is always in the same direction) or adaptive directional (the beam can change direction depending on the location of the desired sound source). Examples of directionals microphones include, but are not limited to, unidirectional microphones (shown by polar pattern 304) and bidirectional microphones (shown by polar pattern 306).

As seen by polar pattern 304, a unidirectional microphone is configured to have a single beam 305 in a first direction and a null 307 in the opposite direction to the beam. In the context of ear-wearable devices the beam 305 is typically configured to be positioned in front of the user and the null 307 is typically configured to be at an angle relative to the front of the user (such as behind the user) when the user wears the ear-wearable device. In various embodiments, unidirectional microphones are configured to emphasize the acoustic signal from the front and sides, while attenuating the acoustic signal from the rear.

As seen by polar pattern 306, a bidirectional microphone is configured to have a first beam 309 facing a first direction and a second beam 308 facing the opposite direction to the first beam. The bidirectional microphone can include a null 310 between the two beams. In the context of ear-wearable devices, the first beam 309 is generally configured to be in front of the user and the second beam 308 is generally configured to be behind the user when the ear-wearable device is worn by the user. The example of FIG. 3 depicts the beams 309, 308 having approximately the same strength. However, in alternative embodiments, beam 309 can have a greater strength than beam 308 (or vis versa). In various embodiments, bidirectional microphones are configured to focus on collecting and amplifying the sound signals in front of and behind an ear-wearable device while lowering sensitivity to the sound signal on both sides of the user. Such a configuration can be useful in specific settings or devices where it is beneficial to capture sound from two opposite directions.

In various embodiments, an ear-wearable device 100 can include one, two, three, or more microphones having any suitable polar pattern; thus, it should be appreciated that many different types of idealized polar patterns can be envisioned for use with an ear-wearable device. It should also be appreciated that the skull, body, and ear of the wearer can alter the effective polar pattern of the ear-wearable device's microphone(s) when worn on or about the ear. In some situations, it may be beneficial for the as-worn polar pattern of the ear-wearable device to be measured or estimated as a means of accounting for the so-called head shadow and pinna effect(s) on the directivity of the ear-wearable device's microphone(s).

### Automated Analysis of Positions for Ear-Wearable Device

Modern ear-wearable devices typically use microphone arrays which allow for directional processing of audio signals. Directional processing can offer improved performance over omnidirectional microphones (e.g., improved signal to noise ratio). However, an ear-wearable device user must understand how to properly orient themselves with respect to their surroundings to receive the benefits of directional processing. In some embodiments, it can be desirable the ear-wearable device user to position a target audio source (e.g., a communication partner) within the most sensitive portion (beam) of the microphone array's polar pattern and to position any potentially extraneous noise sources within the least sensitive portion (null) of the microphone array's polar pattern. It can also be beneficial for individuals to face their communication partners to allow visual speech cues, such as facial, lip, tongue, and jaw movements, to be readily observed.

Ear-wearable device users and communication partners may not intuitively understand how to optimally position themselves when using directional processing or when speaking with individuals with communication impairments, such as hearing loss. Such individuals would benefit from education on positioning techniques. Audiologists generally offer new ear-wearable device users some instruction on positioning techniques. However, some ear-wearable device dispensing models, such as Over-the-Counter (OTC) sales, may not allow for adequate training from an audiologist. Moreover, ear-wearable device users tend to exhibit poor recall of unfamiliar information conveyed during audiologist consultations or otherwise forget their training over time. For many individuals, behavior change is best motivated through real-world experiences in situations that are personally meaningful to them. Accordingly, it can be beneficial to offer reinforced teaching methods outside of a clinical setting.

A system and method of providing guidance regarding optimal positioning to an ear-wearable device user and/or their communication partner can be provided. Such a method can be executed in a processor of an ear-wearable device system. In various embodiments, the ear-wearable device system can include a speaker, a memory storage, and ear-wearable device configured to be worn by the user. The ear-wearable device can include a microphone.

In various embodiments, the method can include receiving input audio from a surrounding environment over a period of time with the microphone. In various embodiments, the method can include creating a spatial map of sound sources in the surrounding environment relative to the first microphone based on the input audio. In various embodiments, the method can include generating a prompt to the user of the ear-wearable device to position themselves relative to the sound sources. In various embodiments, the method can be performed at any suitable time or location by the ear-wearable device user and/or their commination partner without the need for expert intervention.

### Optimal Positioning Strategies User Interface (FIG. 4)

Referring now to FIG. 4, a schematic view of an accessory device 204 showing a user interface related to optimal positioning strategies is shown in accordance with various embodiments herein. The accessory device 204 can include a display 406. In some embodiments, the accessory device 204 can also include a camera 410 and a speaker 408.

The accessory device 204 can be used to prompt the device wearer (and/or a communication partner of the device wearer) visually, audibly, and/or haptically. In various embodiments, the accessory device 204 can be configured to convey a prompt for a device wearer visually on display 406. In various embodiments, the prompt is provided audibly through the speaker 408 and/or though the speaker(s) of the ear-wearable device(s). In various embodiments, the prompt is provided haptically through vibrations of the accessory device 204 and/or the ear-wearable device(s). In some embodiments, the prompt is provided through a separate external accessory device (such as an operably-connected smart watch, or the like).

The accessory device 204 can also be configured to receive input from the device wearer (and/or a communication partner of the device wearer) audibly, through physical interaction, or by the use of gestures. In various embodiments, the accessory device 204 receives the input as a voice command or a sub-vocalized sound such as a tongue click, hum, or the like. In various embodiments, the accessory device 204 is configured to receive input in the form of a head, hand, or body gesture. In various embodiments, the accessory device 204 receives the input as a tactile input or non-tactile input. For example, the display 406 of the accessory device can be a touch screen. In various embodiments, the tactile input can include a tap, swipe, a button press, or the like.

In the example of FIG. 4, the display 406 of the accessory device 204 is displaying a main menu 414 for an ear-wearable device system. In various embodiments, the menu can 414 include a plurality of user input buttons (416, 418, 420, 422, 424). In various embodiments, when the user interacts with one of plurality of user input buttons (e.g., by tapping the display 406), the user is directed to a corresponding rendering generated by the accessory device 204.

In various embodiments, the main menu 414 can include a user input button 416 for optimal positioning tips. In various embodiments, upon selecting the user input button 416, the user is directed towards a page containing guidance on optimal positioning strategies. Such guidance can include positioning tips for different scenarios (e.g., tips on where to sit in a crowded restaurant), recommended ear-wearable device settings for different scenarios (what settings a user should use in a noisy vs. quiet environment), or the like.

In various embodiments, the main menu 414 can include a user input button 418 for generating a spatial map. In various embodiments, upon selecting the user input button 418, the ear-wearable device system will generate a visualization of a spatial map of the user's surroundings. The spatial map can include a map of sound sources in the surrounding environment relative to the ear-wearable device user. In some implementations, the rendered spatial map may statically or dynamically represent one or more of the sound source's relative attributes, such as relative volume, spectral contents, modulation rates, speech contents, captions, etc. For example, a loud sound source may be represented with a more vibrant color, such as bright red, while softer sound sources may be represented with more muted colors, such as pastels. In some implementations, a graphical image may be used to summarize the conversational topic or other attributes of a given sound source. For example, if there were two people speaking in proximity to the ear-wearable device wearer, the graphical images could be used to distinguish between the two talkers and/or conversations. In other examples, a sound source, such as a fan, may be identified and represented with a graphic based on object detection determinations of the ear-wearable device system.

In various embodiments, the main menu 414 can include a user input button 420 for practice exercises. In various embodiments, upon selecting the user input button 420, the user is directed towards a page containing practice exercises. Such practice exercises can include prompting the ear-wearable device user to position themselves in an acoustic environment, simulating ear-wearable device input as a function of position in an acoustic environment, or the like.

In various embodiments, the main menu 414 can include a user input button 422 for user data. In various embodiments, upon selecting the user input button 422, the user is directed towards a page containing user data. Such data can include performance on practice exercises, preferred ear-wearable device settings, or the like.

In various embodiments, the main menu 414 can include a user input button 424 for user settings. In various embodiments, upon selecting the user input button 424, the user is directed towards a page containing user settings. The user settings can include settings for the ear-wearable device(s) and/or the accessory device. Such settings can include volume settings, muting on/off, frequency settings, triggering a particular functionality, telecoil and hearing loop settings, wireless settings, noise reduction settings, directional microphone settings, or the like.

The main menu 414 depicted by FIG. 4 is for exemplary purposes only. In various embodiments, the main menu can include any suitable combination of user input buttons displayed in any suitable arrangement.

### Acoustic Environment Renderings (FIGS. 5-8)

Referring now to FIG. 5, a schematic view of an acoustic environment is shown in accordance with various embodiments herein. In various embodiments the acoustic environment can have a boundary 506. In some embodiments, the boundary 506 can be a physical boundary (e.g., a wall). In some embodiments, the boundary 506 can be a virtual boundary defined by the ear-wearable device system.

In various embodiments, the acoustic environment 500 can include at least one target sound source 502. In the example of FIG. 5, the target sound source 502 can be the voice of a communication partner. While the acoustic environment 500 depicted by FIG. 5 includes a single target sound source, it will be appreciated that the acoustic environment can include any suitable number of target sound sources such as two, three, four, or more target sound sources.

In various embodiments, the acoustic environment 500 can include at least one extraneous sound source 504. In the example of FIG. 5, the extraneous sound source 504 can sound emitted from a television. While the acoustic environment 500 depicted by FIG. 5 includes a single extraneous sound source, it will be appreciated that the acoustic environment can have can include any suitable number of extraneous sound sources such as two, three, four, or more extraneous sound sources.

Depending on the scenario, the target sound source and extraneous sound source can be any source of sound including, but not limited to human voice(s), sound emitted from devices and/or appliances, sound broadcast from a sporting event or performance, ambient noise, or the like.

In various embodiments, an ear-wearable device user 508 can also be positioned within the acoustic environment. In various embodiments the ear-wearable device user 508 can wear a single ear-wearable device or a pair of ear-wearable devices (e.g., ear-wearable devices 100, 200) in a fixed position relative to the user's head.

Referring now to FIG. 6, a schematic view of an accessory device 204 including a user interface for rendering a visual representation of sound sources in an acoustic environment is shown in accordance with various embodiments herein. In the example of FIG. 6, a rendering 602 of the acoustic environment 500 has been generated at the display 406 of the accessory device 204. In some embodiments, such a rendering can be generated upon a user prompting the ear-wearable device system to generate a spatial map of their acoustic environment. For instance, such a rendering can be generated upon a user selecting the user input button 418 titled “Generate Spatial Map” in the main menu 414 depicted by FIG. 4.

In various embodiments, the rendering 602 can include a spatial map of sound sources in the surrounding environment. The sound sources can include one or more target sound sources and/or one or more extraneous sound sources. In the example of FIG. 6, one target sound source 502 and one extraneous sound source 504 have been identified. In various embodiments, the system can label the sound sources. In the example of FIG. 5, the rendering has labeled the target sound source “A” and the extraneous sound source “B.” Any other suitable labeling scheme is possible.

In various embodiments, the ear-wearable device system is configured to categorize the sound sources identified in the acoustic environment. In some implementations, the system can classify the sound sources as either target sound sources or extraneous sound sources. In the example of FIG. 6, the rendering 602 can further include a visual indicator 604 classifying the sound sources. Sound source “A” has been labeled a target sound source and sound source “B” has been labeled an extraneous sound source.

In some embodiments, the rendering 602 can include a visual representation of the ear-wearable device user 508. The visual representation can show where in the acoustic environment 500 the ear-wearable device user 508 is positioned. In some embodiments, the visual representation can show the orientation of the ear-wearable device user's head relative to the sound sources in the acoustic environment 500. In alternative embodiments, the rendering 602 does not include a visual representation of the ear-wearable device user 508.

In some embodiments, the rendering 602 of the acoustic environment 500 is a rendering of the actual surroundings of an ear-wearable device user 508. For instance, the rendering of the acoustic environment can include a spatial map of sound sources surrounding the user in real time. The embodiment of FIG. 6 depicts a rendering 602 of the acoustic environment 500 depicted by FIG. 5. The ear-wearable device system can be configured to generate the rendering 602 of the acoustic environment 500 in any number of ways.

As seen in FIG. 5, an ear-wearable device user 508 can be positioned within the acoustic environment 500. The ear-wearable device user 508 can wear at least one ear-wearable device in a fixed position relative to the user's head. The ear-wearable device(s) can include microphone(s) configured to pick up soundwaves from the surrounding acoustic environment. In various embodiments, the ear-wearable device system is configured to receive input audio from the surrounding environment over a period of time with the microphone. Using the input audio from the microphone, the system is configured to create a spatial map of sound sources in the surrounding environment relative to the microphone based on the input audio.

In some embodiment, the ear-wearable device user 508 can wear a pair of ear-wearable devices (e.g., ear-wearable devices 100, 200). The ear-wearable devices 100, 200 and can each include a microphone (or an array of microphones) and a sensor package and can be disposed on opposing lateral sides of the user's head. In such embodiment, the fixed relationship of the ear-wearable devices with respect to each other can permit triangulation of sound signals. Accordingly, the spatial map of sound sources in the surrounding environment can be created by calculating a distance between the user and the sound sources using the first microphone and the second microphone.

In addition, or alternatively to using microphone(s) to generate the spatial map, the ear-wearable device system can utilize one or more additional sensors. In various embodiments, the ear-wearable device system can be configured to determine the direction that the ear-wearable device user 508 is facing (e.g., the direction that the head of the wearer is facing). In some embodiments, the direction that the head of the ear-wearable device user 508 is pointing can be determined based on the orientation of the ear-wearable device(s) 100, 200 as they are worn by the user. The orientation of the ear-wearable device(s) 100, 200, in turn, be determined using various sensors contained within the ear-wearable devices such as a motion sensor (which could include one or more of an accelerometer, a gyroscope, etc.), a magnetometer, as well as other sensors.

In various embodiments, the ear-wearable device system can include a motion sensor configured to be worn by the user. For example, each of the ear-wearable device(s) can include an IMU. In such an embodiment, the spatial map of sound sources in the surrounding environment can be created tracking origins of the sound sources with the motion sensor as the user moves their head.

In some embodiments, the data from the motion sensor(s) can be used in addition to the data from the microphone(s). For instance, the microphone data may be modified by data inputs received from one or more operatively-connected motion sensors. For instance, the ear-wearable device system may direct the ear-wearable device user 508 to move their head about the acoustic environment. This can allow for successional spatial mapping calculations to be performed as the microphone(s) are moved about the acoustic environment.

In various embodiments, rendering of the acoustic environment can be enhanced by using a spatial mapping sensor. In some embodiments, the spatial mapping sensor can be the camera 410 of the accessory device 204. Alternatively, an external spatial mapping sensor can be used. In various embodiments, the spatial mapping sensor may be one or more of a visual mapping sensor (e.g., RGB cameras, depth cameras, photogrammetry), distance and depth sensor (e.g., LiDAR, ultrasound, time-of-flight sensors), environmental mapping or tagging sensor (e.g., thermal cameras, UWB technology, radio frequency ID systems), and the like. In various embodiments, the spatial mapping sensor is configured to identify various objects within the acoustic environment such as people, types and locations of furniture, other sources of sound (e.g., fans, appliances, televisions, etc.), light sources, windows and window coverings, rugs and flooring, décor, sound treatments (e.g., diffusers and absorption panels), communication partners, or the like. In various embodiments the spatial mapping sensor can be used to generate a physical layout representation, blueprint, floorplan, or schematic of the acoustic environment. Such a floor plan is illustrated by the rendering 602 of FIG. 6.

In some embodiments, rendering of the acoustic environment can be enhanced by user input. For instance, the rendering can be created and/or modified with user input. In an embodiment, the accessory device 204 can be configured to prompt the user to manually identify the spatial location of architectural elements, furniture elements, sound sources, and light sources within the surrounding environment. In an embodiment, the accessory device 204 can be configured to prompt the user to assess the correctness of the layout of the acoustic environment. In an embodiment, the accessory can be configured to prompt the user to manually override aspects of the acoustic environment visualization generated by the system.

In various embodiments, the ear-wearable device system can be configured to identify the target sound source(s) within the acoustic environment 500. In some embodiments, the ear-wearable device system is configured to determine the target sound source(s) based on user input. For instance, upon identifying all the sound sources within the acoustic environment, the system can prompt the ear-wearable device user 508 to select the target sound source(s). In some embodiments, the system can additionally prompt the ear-wearable device user 508 to select the extraneous sound source(s).

In some embodiments, the ear-wearable device system is configured to automatically determine the target sound source(s). In some embodiments, the ear-wearable device system is configured to categorize the most dominant sound source(s) in the acoustic environment as target sound source(s). In some embodiments, the most dominant sound sources can be the sound sources perceived by the ear-wearable device with the highest signal to noise ratio. In some embodiments, the ear-wearable device system is configured to categorize the sound source(s) that the user is facing as the target sound source(s).

In various embodiments, the ear-wearable device system is configured to sore identifying information of one or more communication partners in the memory storage and to identify any of the one or more communication partners within the surrounding environment using the identifying information. In some embodiments, the ear-wearable device system is configured to store the voice profiles of one or more communication partners of the ear-wearable device user in a memory. In some implementations, the ear-wearable system may use one or more suitable statistical or analysis method(s) to assign a probability that a voice sample, obtained in the acoustic environment proximate to the ear-wearable device wearer, sufficiently matches a voice profile stored in memory. In some implementations, a voice sample may be associated with non-acoustic information (e.g., wireless device identifiers, facial images, etc.) that can be recognized by the ear-wearable device system to enhance the robustness of voice profile differentiation and subsequent identification. Upon identifying the voice of a communication partner within the acoustic environment, the ear-wearable device system is configured to categorize the voice as a target sound source.

In some embodiments, the ear-wearable device system is configured to store one or more desired speech sounds within a memory. Upon identifying a desired speech sound within the acoustic environment, the ear-wearable device system is configured to categorize the desired speech sound as a target sound source.

In various embodiments, upon identifying the target sound source(s) the ear-wearable device system is configured to categorize all of the remaining sound sources within the acoustic environment as extraneous sound sources. In various embodiments, the ear-wearable device system is configured to prompt the user to confirm or modify the categorization of the target sound source(s) and/or the extraneous sound source(s).

In some configurations, the ear-wearable service system is configured to generate renderings of virtual acoustic environments. Such renderings can contain examples of acoustic environments that an ear-wearable device user may encounter such as a restaurant, an outdoor gathering, a sporting event, a classroom, or the like. In various embodiments, the simulated acoustic environments can be stored in a memory of the ear-wearable device system. In various embodiments, the simulated acoustic environments can be used to assist an ear-wearable device user in practicing optimal positioning strategies.

The rendering shown in the example of FIG. 6 includes a visual representation of the spatial map of sound sources. However, the rendering may be generated in any other suitable manner.

Referring now to FIG. 7, a schematic view of an accessory device 204 including a user interface for rendering a visual representation of sound sources in an acoustic environment is shown in accordance with various embodiments herein. In the example of FIG. 7, a rendering 702 of the acoustic environment 500 has been generated at the display 406 of the accessory device 204.

The rendering 702 of FIG. 7 is of the same acoustic environment 500 as rendered in the example of FIG. 6. However, rather than generating a floorplan of the surrounding environment (as done by the rendering of FIG. 6), the rendering of FIG. 7 uses text to identify and categorize the sound sources in the acoustic environment.

In various embodiments, the rendering 702 can include a visual representation of sound sources in the surrounding environment. The sound sources can include one or more target sound sources and/or one or more extraneous sound sources. In the example of FIG. 7, one target sound source 502 and one extraneous sound source 504 have been identified. In various embodiments, the system can label the sound sources. For instance, the rendering can include a list 704 of all the identified sound sources.

In various embodiments, the list 704 contains two categories of sound sources: target sound sources and extraneous sound sources. For each sound source, the list can include the name of the sound source and a location of the sound source. In some embodiments, the location of the sound source is given relative to a position of the ear-wearable device wear as determined by the ear-wearable device system. In various embodiments, the ear-wearable device system is configured to determine and categorize each of the sound sources in the acoustic environment. In the example of FIG. 7, the rendering 702 lists the target sound source as being a communication partner located to the left of the user and the extraneous sound source as being a television to the right of the user.

In various embodiments, the ear-wearable device user can confirm or modify the accuracy of the identified sound source. In some moments, the list 704 includes one or more user input buttons 706. The user input buttons can be associated with each sound source. For instance, the user input button 706 can be used to confirm or modify a sound source. If a sound source listed in the rendering is correct, the user can hit “confirm” to confirm that the name, location, and categorization of the sound source is correct. If a sound source listed in the rendering is incorrect, the user can hit “modify” to modify the name location and/or categorization of the sound source.

In various embodiments, the ear-wearable device system can determine or otherwise estimate the RT60 reverberation time of the acoustic environment proximate to the ear-worn device wearer. In some implementations, the microphone of ear-worn device or an operatively connected accessory device is used to measure sound decay in response to an impulsive sound source, such as a clap or a burst noise, present in the acoustic environment. In some implementations, samples of more frequently occurring sounds, such as running speech, can be collected. The collected acoustic data is analyzed to calculate the time taken for the sound energy to decay by 60 decibels (dB), providing the RT60 metric, which is a standardized method of characterizing the reverberation present withing the space. In some implementations, it may be beneficial to calculate the amount of time for the sound energy to decay by fewer than 60 dB (e.g., 30 dB, 15 dB, etc.) such that the conditions for a valid measurement from the ear-wearable device system can be more readily reached in uncontrolled acoustic environments and situations.

In various embodiments, the rendering 702 can include a guidance window 708. The guidance window can provide guidance to the ear-wearable device user as to how to optimally position themselves relative to the sound sources in the acoustic environment. In various embodiments, the ear-wearable device system will provide guidance based upon the relative distance, loudness, spectral composition, and angle of incidence of various sound sources. In some implementations the ear-wearable device system will provide guidance that is additionally or alternatively based upon one or more of the calculated or estimated reverberation time of the acoustical space and signal-to-noise ratio (SNR) of the target sound source(s) relative to the extraneous sound source(s). In some embodiments, a user may manually input the RT60 reverberation time metric, or the ear-wearable device system may receive a previously calculated RT60 reverberation time metric from a wireless beacon (e.g., NFMI, RFID, etc. present in or about the acoustical space) or a virtual beacon (e.g., geofence or the like) being used to provide information about the acoustical space. For various embodiments, it should be appreciated that one or more of these data may be included in the generation of spatial maps and/or subsequent guidance.

In the example of FIG. 7, the guidance includes generating a prompt to the user of the ear-wearable device as to how to position themselves relative to the sound sources. In various embodiments, the prompt can be based on information generated by the spatial map. In this instance, the prompt states “Orient yourself towards your partner and away from the television.” In some instances, the prompt states a specific distance for positioning the ear-wearable device wearer with respect to the target sound source. Additionally, or alternatively, to being displayed by the accessory device, the guidance can be conveyed audibly to the ear-wearable device user through the speaker 408 of the accessory device and/or though the speaker(s) of the ear-wearable device(s).

FIGS. 6-7 illustrate two different renderings of a spatial map of sound sources in an acoustic environment. However, any other suitable spatial map rendering is possible. In various embodiments, the ear-wearable device system can generate one, two, three, or more different renderings of the same acoustic environment. In various embodies, the ear-wearable device user can interact with the accessory device to switch between the renderings to better understand the acoustic environment.

Referring now to FIG. 8, a schematic view of an accessory device 204 including a user interface for rendering a visual representation of sound sources in an acoustic environment is shown in accordance with various embodiments herein. In the example of FIG. 8, a rendering of the acoustic environment 500 has been generated at the display 406 of the accessory device 204. The rendering 802 of FIG. 8 is the same as the rendering 602 of FIG. 6 but depicts an alternative rendering 808 ear-wearable device user positioned within the acoustic environment 500. In various embodiments, the alternative rendering 808 of the ear-wearable device user can depict an optimal positioning of the ear-wearable device user within the acoustic environment.

In some embodiments, the alternative rendering 808 of the ear-wearable device user positioned within the acoustic environment 500 can include one or more visual cues. In the example of FIG. 8, the alternative rendering 808 can include a border 814 and a vector 816. In various embodiments, the border 814 can illustrate a zone in the acoustic environment where the user can position themselves to achieve optimal positioning. In various embodiments, the vector 816 can illustrate the orientation of the user's head for optimal positioning. The vector 816 can help clarify to the user as to what direction they should orient themselves in. In various embodiments, the rendering 802 can include any other suitable visual cues or cues to aid the user in positioning themselves within the acoustic environment.

In some embodiments, the alternative rendering 808 of the ear-wearable device user positioned within the acoustic environment 500 can be an exemplary position determined by the ear-wearable device system. In various embodiments, the ear-wearable device system is configured to generate a prompt 804 to the user of the ear-wearable device to position themselves relative to the sound sources. The prompt 804 can instruct the user to position themselves as demonstrated by the alternative rendering 808. In the example of FIG. 8, the prompt takes the form of a visual rendering. Alternatively, the prompt can be conveyed audibly to the ear-wearable device user.

In various embodiments, the optimal positioning for the ear-wearable device user 508 can be based at least in part on the configuration of the ear-wearable device(s) worn by the user, which may include programming data as well as audiologic and case history data regarding the ear-wearable device wearer. In various embodiments, the optimal positioning for the ear-wearable device user 508 can be based at least in part on the acoustic properties of the target sound source(s) relative to extraneous sound source(s), such as the SNR. In various embodiments, the optimal positioning for the ear-wearable device user 508 can be based at least in part on the acoustic properties of the acoustic environment, such as RT60 reverberation time and room impulse response(s). In various embodiments, the ear-wearable device user 508 can be wearing a single ear-wearable device or a pair of ear-wearable devices with each ear-wearable device having a microphone or array of microphones.

In some embodiments, the ear-wearable device(s) can each include one or more directional microphones. Each of the directional microphones can include a beam in front of the user and null being at an angle relative to the front of the user when the user wears the ear-wearable device. To maximize the benefits of directional audio processing, it is generally advised the user should position themselves with the beam of the directional microphone facing towards the target sound source and with any extraneous sound sources facing away from the beam.

In various embodiments, prompting the user to position themselves relative to the sound sources includes prompting the user to face towards the target sound source. In various embodiments, prompting the user to position themselves relative to the sound sources includes prompting the user to be within a certain range or distances (e.g., 0.5-1.0 meters) relative to the sound target sound source(s). As seen in FIG. 8, the vector 816 points towards the target sound source. The border 814 depicts a location of the ear-wearable device wearer that is within 0.5-1.0 meters from the target sound source 502. Such a configuration places the target sound source in the effective beam of the directional microphone(s). This can enhance the volume, SNR, and clarity of sound originating from the target sound source.

In various embodiments, prompting the user to position themselves relative to the sound sources comprises prompting the user to face at an angle relative to the extraneous sound source. As seen in FIG. 8, the vector 816 points away the extraneous sound source. Such a configuration places the extraneous sound source away from the beam and/or in the null of the directional microphone(s). This can decrease the relative strength of sounds originating from extraneous sound sources as received by the ear-wearable device(s).

In various embodiments, the rendering can be further configured to identify and categorize other types of stimuli (e.g., suboptimal lighting, distracting objects, etc.) that may interfere with the era-wearable device user's understanding of speech. In various embodiments, prompting the user to position themselves relative to the sound sources comprises prompting the user to face at an angle and/or distance relative to such stimuli.

In various embodiments, the optimal positioning generated by the ear-wearable device system is configured to enhance the target sound source(s) perceived by the ear-wearable device user while diminishing the extraneous sound source(s). The optimal positioning can be determined in any suitable way. As described in the context of FIG. 6, the ear-wearable device system is configured to identify and classify the sound sources within an acoustic environment.

Upon identifying and categorizing one or more of the acoustic environment and target sound sources, the ear-wearable device system can be configured to calculate a SNR favorability value for the target sound source in one or more possible positions within the acoustic environment. The ear-wearable device can then prompt the ear-wearable device user to assume the position with the SNR favorability value.

In some embodiments, the ear-wearable device system can compare a calculated SNR favorability value of the target sound source where the user is currently positioned to a calculated SNR favorability value of other locations relative to the ear-wearable device user. The optimal positioning can be selected based on which location has the SNR favorability value. If the user is not optimally positioned, the system can generate a prompt to have the user move to an optimal positioning.

In various embodiments, the ear-wearable device system is configured to generate one or more outputs configured to assist the ear-wearable device user to optimally position themselves within the acoustic environment. Additionally, or alternatively, the ear-wearable device system is configured to generate one or more outputs configured to assist the communication partner(s) of ear-wearable device user to optimally position themselves within the acoustic environment. In the example of FIG. 8 the system may provide a visual rendering 802 that indicates a present location of the ear-wearable device user 508 and a preferred location of the ear-wearable device user (shown by alternative rendering 808).

In some embodiments, the rendering can further include a comparative indication. The comparative indication can include an indication of at least one more desirable place and at least one less desirable place for the user to position themselves within the surrounding environment based on the sound sources. In various embodiments, the ear-wearable device system is configured to convey the comparative indication to a third party.

In various embodiments, the ear-wearable device system is configured to utilize one or more operatively connected motion sensors to continuously update the positioning of the ear-wearable device user within the acoustic environment. Using this information, the ear-wearable device system can determine whether or not the user has moved to the optimal position after receiving a prompt and provide additional feedback to the user accordingly. The ear-wearable device system can continuously calculate the signal to-noise ratio favorability values within an acoustic environment and update the guidance given to the user accordingly.

### Alternative Acoustic Environment Rendering (FIGS. 9-11)

Referring now to FIG. 9, a schematic view of an acoustic environment is shown in accordance with various embodiments herein. In various embodiments the acoustic environment 900 can have a boundary 906. In some embodiments, the boundary 906 can be a physical boundary (e.g., a wall). In some embodiments, the boundary 906 can be a virtual boundary defined by the ear-wearable device system.

In various embodiments, the acoustic environment 900 can include at least one target sound source 902. In the example of FIG. 9, the target sound source 902 can be the voice of a communication partner. In various embodiments, the acoustic environment 500 can include at least one extraneous sound source 904. In the example of FIG. 9, a first extraneous sound source 904 can sound emitted from a television and a second extraneous sound source 910 can be ambient noises coming from an external window.

In various embodiments, an ear-wearable device user 508 can also be positioned within the acoustic environment. In various embodiments the ear-wearable device user 508 can wear a single ear-wearable device or a pair of ear-wearable devices (e.g., ear-wearable devices 100, 200) in a fixed position relative to the user's head.

Referring now to FIG. 10, a schematic view of an accessory device 204 including a user interface for rendering a prompt is shown in accordance with various embodiments herein. In various embodiments, the ear-wearable device system can be configured to generate a simulation of an acoustic environment at the display device. The ear-wearable device system can use the simulated acoustic environment to provide information and/or training to the ear-wearable deice user and their communication partner. FIG. 10 provides one such example of training for the ear-wearable deice user in which the accessory device prompts the user to select ideal locations to have a conversation within a simulated acoustic environment. In various embodiment, the ear-wearable device user can interact with the prompt by selecting input button 1002.

In various embodiments, the rendering of the acoustic environment generated at the display device can include a visual representation of one or more audio sources. In various embodiments, the ear-wearable device system can be configured to identify a plurality of possible body positions and/or head orientations that a simulated ear-wearable device user can have within the acoustic environment. In various embodiments, the ear-wearable device system can be configured to score the plurality of possible body positions. In various embodiments, the ear-wearable device system can be configured to receive a selected body position which comprises a selection of one of the possible body positions from the plurality of possible body positions. In various embodiments, the ear-wearable device system can be configured to provide feedback to the user or the communication partner based on a score of the selected body position.

Referring now to FIG. 11, a schematic view of an accessory device 204 including a user interface for rendering a visual representation of sound sources in an acoustic environment is shown in accordance with various embodiments herein. In the example of FIG. 11, a rendering 1102 of the acoustic environment 900 has been generated at the display 406 of the accessory device 204. In some embodiments, such a rendering can be generated upon a user prompting the ear-wearable device system to generate a spatial map. In some embodiments, such a rendering can be generated upon a user selecting the user input button 418 titled “Generate Spatial Map” in the main menu 414 depicted by FIG. 4. In some embodiments, such a rendering can be generated upon a user selecting the user input button 1002 titled “proceed” below the prompt depicted by FIG. 10. Alternatively, the rendering can be of a simulated acoustic environment.

After engaging with prompt shown in FIG. 10 the rendering 1102 of FIG. 11 can appear on the display 406 of the accessory device 204. In various embodiments, the rendering 1102 can include a spatial map of sound sources in the surrounding environment. The sound sources can include one or more target sound sources and/or one or more extraneous sound sources. In the example of FIG. 11, one target sound source and two extraneous sound sources have been identified. In various embodiments, the system can label the sound sources. In the example of FIG. 5, the rendering has labeled the target sound source “A” and the extraneous sound sources “B” and “C.”

In various embodiments the ear-wearable device system is configured to categorize the sound sources identified in the acoustic environment. The system can classify the sound sources as either target sound sources or extraneous sound sources. In the example of FIG. 11, the rendering 1102 can further include a visual indicator 1104 that classifies the sound sources. Sound source “A” has been labeled a target sound source and sound sources “B” and “C” have been labeled as extraneous sound sources.

In various embodiments, the ear-wearable device system can be configured to instruct ear-wearable device users and their communication partners on how to position themselves using a simulated acoustic environment generated on an accessory device. In the example of FIG. 11, the rendering contains a plurality of positioning options labeled 1, 2, 3, 4, and 5. In various embodiments, each positioning option represents a possible location in an ear-wearable device user can position themselves within the acoustic environment.

In various embodiments, the ear-wearable device system can be configured to score the plurality of possible body positions. For instance, the ear-wearable device system can be configured to calculate a SNR favorability value for the target sound source for each of the positioning options (1, 2, 3, 4, 5) within the acoustic environment. The positioning option with the highest SNR favorability value can receive the highest score and the positioning option with the lowest SNR favorability value can receive the lowest score.

In various embodiments, positioning options can include body positions and head orientations. In various embodiments, scoring the plurality of possible body positions can include assigning higher scores to body positions and/or head orientations that maximize the signal to noise ratio of the target sound source. It should be appreciated that the guidance provided to the user may also factor cultural and social pragmatics that may effectively deter the user from assuming socially unacceptable positions (i.e., maintaining the comfortable “social bubble”) despite the potentially high SNR favorability of the same. In various embodiments, the acoustic environment includes at least one extraneous sound source, and scoring the plurality of possible body positions includes assigning higher scores to body positions and/or head orientations that minimize the impact of the extraneous sound source.

In various embodiments, the ear-wearable device user can interact with the rendering 1102. For instance, the ear-wearable device user can select one or more optimal positions out of the plurality of position options (1, 2, 3, 4, 5). The user can make the selection by tapping on or more of the position option icons (1, 2, 3, 4, 5), speaking into the microphone, or the like. In various embodiments, the ear-wearable device system is configured to receive a selection of one or more of the position options and to provide feedback on a score of the selected body position. In various embodiments, providing feedback to the user or the communication partner comprises confirming the selected body position if the selected body position scores above a threshold value. For instance, if the user selects the highest scoring position of the plurality of positioning options (1, 2, 3, 4, 5), the ear-wearable device system can provide positive feedback to the user confirm their choice.

In various embodiments, providing feedback to the user or the communication partner comprises providing feedback on the selected body position if the selected body position scores below a threshold value. For instance, if the user selects one of the lower scoring positions of the plurality of positioning options (1, 2, 3, 4, 5), the ear-wearable device system can provide constructive feedback to the user. For instance, the system can prompt the user to select a different position option and/or reveal the highest scoring position to the user.

In various embodiments, the ear-wearable device system is configured to generate audio samples for each of the plurality of position options. Each audio simulation is configured to simulate how the ear-wearable device user would hear the target sound if they were to assume the corresponding position. In various embodies, the ear-wearable device user can listen to any of the audio samples by interacting with the accessory device. For example, the user can play a selected audio sample by tapping on or more of the position option icons (1, 2, 3, 4, 5), speaking into the microphone, or the like.

In some embodiments, selecting an optimal positioning out of the plurality of position options, the ear wearable system can generate a first simulated audio recording of the acoustic environment that a simulated user would hear based on the selected body position. The system can then generate a second simulated audio recording of the acoustic environment that the simulated user would hear based on a highest scoring body position. Such a configuration can allow for the ear-wearable device user to observe how sound quality changes as a function of position.

In various embodiments, the ear-wearable device system is configured to generate recommendations for adding, removing, or altering architectural and environmental elements within the acoustic environment. For example, upon generating a rendering of the acoustic environment, the ear-wearable device system may determine that one or more properties of the acoustic environment (e.g., reverberation decay time) is sub-optimal. Upon making such a determination the ear-wearable device system can provide one or more recommendations to the user. Such recommendations can include adding curtains, décor, rugs, sound treatments, or the like to reduce the amount of reverberation in the acoustic environment. In some embodiments, the ear-wearable device system may provide an estimated metric to express an anticipated amount of improvement that a suggested modification may have on the acoustic environment. Such metrics can include the amount of reduction in anticipated reverberation time, speech intelligibility improvement, listening effort improvement, or the like. In some embodiments, the system may use augmented reality to provide a visual demonstration of how the acoustic environment might look with the proposed modifications.

In some embodiments, the rendering of the acoustic environment can allow the user to simulate movement or orientation of one or more of the user, communication partner(s), and/or architectural and environmental elements to understand how those changes affect the sound quality, speech intelligibility, or the like. In some embodiments, simulated audio recordings can be prepared for the user to simulate the impact of such changes. In some embodiments, calculated or estimated metrics can be displayed for each simulated positioning.

### Communication Strategies and Repair

Ear-wearable device users and their communication partners may not intuitively understand optimal communication and communication repair strategies. Poor implementation of communication repair strategies can become a source of tension between communication partners. Accordingly, it is desirable to provide education to ear-wearable device users and their communication partners.

A system and method of providing guidance regarding communication strategies and repair to an ear-wearable device user and/or their communication partner can be provided. Such a method can be executed in a processor of a feedback system having a microphone and a memory storage.

In various embodiments, the method can include monitoring a voice output of the user with the microphone. In various embodiments, the method can include processing the voice output of the user by at least one of counting a first number of instances in which the user implements a positive communication repair strategy and counting a second number of instances in which the user implements a negative communication repair strategy. In various embodiments, the method can include generating feedback indicative of the first number of instances, the second number of instances, or both the first number of instances and the second number of instances.

### Positive and Negative Communication Strategy Examples (FIGS. 12-13)

Referring now to FIGS. 12-13, examples of communication strategies are depicted herein. FIG. 12 depicts an example scenario of poor communication between an ear-wearable device user and their communication partner. FIG. 13 depicts an example scenario of good communication between an ear-wearable device user and their communication partner.

FIGS. 12-13 both depict an ear-wearable device user 508 having a conversation with their communication partner 1202. The ear-wearable device user can be wearing a single ear-wearable device 100 or a pair of ear-wearable devices 100, 200. The ear-wearable device user 508 and/or the communication partner 1202 can engage with an accessory device 204. In some embodiments, the ear-wearable device user 508 and the communication partner 1202 can engage with the same accessory device 204. In some embodiments, the ear-wearable device user 508 and the communication partner 1202 can each engage with their own accessory device 204.

Poor implementation of communication repair strategies can become a source of tension between communication partners. For example, if an ear-wearable device user always says “what?” whenever they mishear something, their communication partner says to them, the communication partner maybe become frustrated. Ideally, the individual who misheard would identify which portion of the sentence that they misheard instead of effectively asking their communication partner to repeat back everything that they had already said.

In the communication scenario depicted by FIGS. 12-13, the communication partner 1202 says “I am going to visit my brother in Michigan tomorrow.” The ear-wearable device user 508 does not understand where the partner said they were visiting. In the scenario of FIG. 12, the ear-wearable device user 508 replies with the phrase “what?” Such a phrase does not convey any information to the communication partner 1202 as to what part of the statement the ear-wearable device user 508 could not understand. Rather than repeating just the portion of their sentence that the ear-wearable device user could not understand (e.g., where the communication partner is visiting), the communication partner 1202 will have to repeat the whole phrase back to the ear-wearable device user. The ear-wearable device system can record one count 1204 of a negative communication strategy. It should be appreciated that various other words, phrases, silence, and non-verbal communication gestures may be employed as forms of negative repair strategies. In various embodiments, these may also be detected and counted by the ear-wearable device system.

In the communication scenario depicted by FIG. 13, the ear-wearable device user 508 instead replies with the phrase “Where are you going?” This type of reply gives the communication partner clarity as to as to what the ear-wearable device user could not understand. Rather than having to repeat their whole sentence back to the ear-wearable device user, the communication partner can just reply “Michigan.” The ear-wearable device system can record one count 1304 of a positive communication strategy.

Another benefit to this type of communication strategy is that when the ear-wearable device user 508 clearly indicates what part of the sentence they could not understand, the communication partner may gain insight on where they might be using ineffective communication. Examples of ineffective communication can include speaking too quietly, speaking too quickly, facing away from the ear-wearable device user, using unfamiliar words and jargon, or the like.

### Communication Strategy User Interface (FIG. 14)

Referring now to FIG. 14, a schematic view of an accessory device 204 showing a user interface related to communication strategies, in accordance with various embodiments herein. The accessory device 204 can include a display 406. In some embodiments, the accessory device 204 can also include a camera 410, a speaker 408, and a microphone (not shown).

In the example of FIG. 14, the display 406 of the accessory device 204 is displaying a main menu 1414 for an ear-wearable device system. In various embodiments, the menu can 414 include a plurality of user input buttons (1416, 1418, 1420, 1422, 1424). In various embodiments, when the user interacts with one of plurality of user input buttons (e.g., by tapping the display 406), the user is directed to a corresponding rendering generated by the accessory device 204.

In various embodiments, the main menu 1414 can include a user input button 1416 for communication repair strategy tips. In various embodiments, upon selecting the user input button 416, the user is directed towards a page containing guidance on communication strategies. Such guidance can include examples of positive and negative communication repair strategies, guidance on how to seek clarification when a misunderstanding in conversation occurs, guidance on how to speak clearly to individuals with impaired hearing, or the like.

In various embodiments, the main menu 1414 can include a user input button 1418 for communication monitoring. In various embodiments, upon selecting the user input button 1418, the ear-wearable device system monitors the communication of the ear-wearable device user and/or the communication partner. As will be described in detail herein, the ear-wearable device system can monitor the communication for positive and negative communication strategies.

In various embodiments, the main menu 1414 can include a user input button 1420 for practice exercises. In various embodiments, upon selecting the user input button 1420, the user is directed towards a page containing practice exercises. As will be described in detail herein, such practice exercises can include conversations with a simulated communication partner.

In various embodiments, the main menu 1414 can include a user input button 1422 for user data. In various embodiments, upon selecting the user input button 1422, the user is directed towards a page containing user data. Such data can include performance on practice exercises, preferred ear-wearable device settings, or the like.

In various embodiments, the main menu 1414 can include a user input button 424 for user settings. In various embodiments, upon selecting the user input button 1424, the user is directed towards a page containing user settings. The user settings can include settings for the ear-wearable device(s) and/or the accessory device. Such settings can include volume settings, muting on/off, frequency settings, triggering a particular functionality, telecoil and hearing loop settings, wireless settings, noise reduction settings, directional microphone settings, or the like.

The main menu 1414 depicted by FIG. 14 is for exemplary purposes only. In various embodiments, the main menu can include any suitable combination of user input buttons displayed in any suitable arrangement.

### Communication Monitoring and Repair (FIGS. 15-18)

In various embodiments, the ear-wearable device system is configured to provide guidance regarding communication strategies and repair to an ear-wearable device user and/or their communication partner. In various embodiments, the ear-wearable device system is configured to monitor a voice output of the ear-wearable device user 508 and/or the communication partner 1202 with a microphone. The ear-wearable device system may use the microphones integrated into the ear-wearable device(s) 100, 200 and/or the accessory device 204 to monitor the voice output. Additionally, or alternatively, the ear-wearable device system may use one or more external microphones to monitor the voice output.

In some embodiments, the ear-wearable device system is configured to begin monitoring the voice output upon receiving input from the ear-wearable device user 508 or the communication partner 1202. For instance, the ear-wearable device system can begin monitoring the voice output upon the ear-wearable device user 508 or the communication partner 1202 selecting the user input button 1418 titled “Monitor my Communication” on the display 406, speaking one or more key words into the microphone, or the like. In some embodiments, the ear-wearable device system is configured to automatically begin monitoring the voice output. For instance, the ear-wearable device system can begin monitoring the voice output upon detecting the voice of the ear-wearable device user 508 and/or the communication partner 1202. In some jurisdictions, it may be advantageous for the ear-wearable device system to obtain consent from both the ear-wearable device user 508 and the communication partner 1202 before the ear-wearable device system obtains and/or analyzes the contents of conversation audio samples. In some embodiments, the ear-wearable device system may be configured to use location data (e.g., using the GPS of accessory device 204) to determine and operate the ear-wearable device system in a manner that is in compliance with the users'local ordinances pertaining to the collection of conversation audio samples.

In some examples, the ear-wearable device system may obtain audio data from the microphone(s) over time. In some examples, the ear-wearable device system may obtain audio data from microphone(s) every second, every minute, hourly, daily, etc., or may obtain audio data from microphone(s) in an aperiodic fashion. For example, the ear-wearable device system may be preconfigured to control microphone(s) to perform audio recording every twenty minutes for a predetermined number of hours, such as between 8 a.m. and 5 p.m. As another example, the ear-wearable device user 508 and/or the communication partner 1202 may manually control the speech assessment system to obtain audio data from microphone(s) to perform random audio recording at random times during a set time period (e.g., randomly throughout each day).

In some embodiments, the ear-wearable device system is configured to finish monitoring the voice output upon receiving input from the ear-wearable device user 508 or the communication partner 1202. For instance, the ear-wearable device system can finish monitoring the voice output upon the ear-wearable device user 508 or the communication partner 1202 interacting with the display 406, speaking one or more key words into the microphone, or the like.

In some embodiments, the ear-wearable device system is configured to automatically finish monitoring the voice output. For instance, the ear-wearable device system can finish monitoring the voice output after a predetermined time interval has elapsed. In some embodiments, the predetermined time interval can be greater than or equal to 1, 5, 10, 15, or 30 minutes, or can be an amount falling within a range between any of the foregoing. Alternatively, the ear-wearable device system can finish monitoring the voice output after not detecting the voices of the ear-wearable device user 508 or the communication partner 1202 for a predetermined time interval. In some embodiments, the predetermined time interval can be greater than or equal to 1, 5, 10, 15, or 30 minutes, or can be an amount falling within a range between any of the foregoing.

In various embodiments, the ear-wearable device system is configured to process the voice output of the ear-wearable device user 508 and/or the communication partner 1202. In various embodiments, processing the voice output can include distinguishing between speech or sounds associated with the ear-wearable device user, speech or sounds associated with the communication partner, and speech or sounds associated with third party speaker(s). Distinguishing between the sources of speech or sounds can be performed in various ways.

In various embodiments, the ear-wearable device system is configured to store voice profiles for the ear-wearable device user and for individuals that the ear-wearable device user 508 regularly interacts with (e.g., the communication partner 1202), along with a name and user relationship associated with each stored voice profile. The system can use these voice profiles to compare to a voice profile in the voice output, and through that comparison identify the person or people speaking in the audio output.

In some embodiments, distinguishing the voice of the ear-wearable device user and/or the communication partner from other voices can be performed through signal analysis of the signals generated from the microphone(s). For example, in some embodiments, this can be done by filtering out frequencies of sound that are not associated with speech of the ear-wearable device user and/or the communication partner. In some embodiments, such as where there are two or more microphones (on the same ear-wearable device, on different ear-wearable devices, or on accessory devices) this can be done through spatial localization of the origin of the speech or other sounds and filtering out, spectrally subtracting, or otherwise discarding sounds that do not have an origin within the device wearer. In some embodiments, such as where there are two or more ear-wearable devices, own-voice detection can be performed and/or enhanced through correlation or matching of intensity levels and or timing.

In some embodiments, a voice sample may be associated with non-acoustic information (e.g., wireless device identifiers, facial images, etc.) that can be recognized by the ear-wearable device system to enhance the robustness of communication partner voice profile differentiation and subsequent communication partner identification.

In various embodiments, processing the voice output can include transcribing the contents of the voice output. The audio data can be converted into a text-based transcript. The conversion from audio data to text-based transcript can be performed by a speech to text programs that are currently available. In some embodiments, a speech-to-text module can be included within the system herein or can be accessed as part of a remote system such as an API. For example, one such speech-to-text API is the Google Cloud Speech-to-Text API, wherein files/data representing speech can be submitted and text can be retrieved. Another is the speech service API from Microsoft Azure Cognitive Speech Services.

A transcript or notes from a verbal interaction can be delivered to the ear-wearable device user 508 and/or the communication partner 1202, such as using an application running on the accessory device 204. In some embodiments, an application designed to be used by the ear-wearable device user 508 and/or the communication partner 1202 is used to display the transcript or notes to the wearer. In various embodiments, the communication partner can have their own accessory device, and a companion application is present on the communication partner's accessory device. In one example, the transcript provided by the system is sent by the ear-wearable device user's application through the internet to the companion application at the communication partner's accessory device.

Referring now to FIG. 15, a schematic view of an accessory device 204 including a user interface for presenting a transcript is shown in accordance with various embodiments herein. The display 406 can display a rendering of a transcript 1502 of a voice output. In one example shown in FIG. 15, the accessory device 204 presents a transcript including text from the voice output generated by two different speakers: the ear-wearable device user 508 and their communication partner 1202.

Upon distinguishing between speech or sounds associated with the ear-wearable device user from speech or sounds associated with the communication partner, the transcript can assign a character (e.g., A, B), graphic (e.g., avatar, photo, image, etc.) for each speaker. The transcript 1502 can display the spoken text next to the assigned character for each speaker. The display 406 can also include a legend 1504 showing the individual assigned to each label. In the example of FIG. 15, the ear-wearable device user is assigned the character “A”, and the communication partner is assigned the character “B.”

In various embodiments the voice output can be analyzed to extract data, such as vocal pitch and vocal tone, speech cadence, word patterns, word frequencies, total time spent speaking, and other information conveyed in the speaker's voice and speech. In various embodiments, the voice output can further be analyzed for clarity, breathiness, pitch change, vowel instability, and/or roughness of the ear-wearable device user's speech.

In various embodiments, processing the voice output can include classifying the contents of the voice output. In some cases, the content can include the words that are spoken by the ear-wearable device user and/or the communication partner. In various embodiments, the ear-wearable device system can be configured to identify and classify words in any number of languages and/or dialects. In some cases, the content can include the sounds (i.e., phonemes) or sound patterns other than words that are uttered by the ear-wearable device user and/or the communication partner. In some cases, the content can include both the words and other sounds or sound patterns.

Signals reflecting the speech utterances of the ear-wearable device user and/or the communication partner can be transcribed into words or phonemes (i.e., speech recognition) in various ways. In some embodiments, the system can evaluate the number or classification of words or phonemes reflecting confusion as uttered by the ear-wearable device user and/or the communication partner can be tracked. Words of confusion can include question words such as what, who, why, when, where, uh, huh, say what, excuse me, pardon, come again, as well as others. In various embodiments, the ear-wearable device system can be configured to identify and classify words of confusion in any number of languages and/or dialects. In various embodiments, the ear-wearable device system can be configured to identify other markers of confusion, such as vocal inflections, pauses, and non-verbal gestures.

Referring now to FIG. 16, a portion of the voice output is transformed into a text-based transcript by the ear-wearable device system. Upon distinguishing between speech or sounds associated with the ear-wearable device user from speech or sounds associated with the communication partner, the transcript can assign a character (A, B) for each speaker. The transcript can label the text spoken by the communication partner “A” and the text spoken by the ear-wearable device user “B.”

In various embodiments, the ear-wearable device system is configured to detect lexical units in the voice output. A lexical unit as defined herein is a single word, a part of a word, or a chain of words that forms a meaningful element of language. Lexical units can function as building blocks for understanding language in machine learning models. Lexical units can include any of nouns, verbs, adjectives, adverbs, conjunctions, determiners, interrogatives, prepositions, interjections, expletives, articles, or the like. Recognizing these parts of speech allows the ear-wearable device system to understand the structure of the sentence and the relationship between its elements. In various embodiments, the ear-wearable device system can be configured to identify and classify lexical units in any number of languages and/or dialects. It should be appreciated that there are several ways that the ear-wearable device system may be configured such that the rules and norms of a particular dialect/language are applied for a given user (e.g., referencing location services of accessory device 204, manual input from the user, historical patterns of the user, etc.).

In the example of FIG. 16, the transcript data can include the voice output 1602 spoken by the ear-wearable device user and the communication partner along with the corresponding lexical units 1604. The ear-wearable device can be configured to classify the lexical unit “I” as a pronoun (Nₚᵣ), the lexical unit “am” as an auxiliary verb (Vₐᵤ), the lexical unit “going” as a present participle verb (Vₚ), the lexical unit “to” as particle (P), the lexical unit “visit” as a base form verb (V_{B}), the lexical unit “my” as a possessive determiner verb (Dₚ), the lexical unit “brother” as a present participle verb (Vₚ), the lexical unit “in” as a preposition (P), the lexical unit “Michigan” as a proper noun (P_{N}), the lexical unit “tomorrow” as an adverb (AV), and the lexical unit “What” as an interrogative (I).

In some embodiments, the ear-wearable device can be configured to identify the end of each phrase. In the example of FIG. 16, the transcript data can include an appropriate punctuation mark at the end of each phrase. For instance, the transcript data shows a first phrase (spoken by the communication partner) ending in a period and a second phrase (spoken by the ear-wearable device user) ending in a question mark. The ear-wearable device system can be configured to determine the appropriate punctuation for each phrase based on any number of factors including the inflection of the speaker's voice, the lexical units in the phrase, or the like.

In various embodiments, the ear-wearable device can be configured to classify at least one of the lexical units as a discourse marker of a plurality of discourse markers. In some embodiments, the plurality of discourse markers can include question words. Question words, alternatively known as interrogative words, can be any utterance indicating that a speaker is confused or has a question about something such as what who, why, when, where, uh, huh, say what, excuse me, pardon, come again, or the like. In various embodiments, the ear-wearable device system can be configured to identify and classify question words in any number of languages and/or dialects. In the example of FIG. 16, the ear-wearable system is configured to flag any instances of such discourse markers in the transcript data. For instance, the phrase “what” has been classified as an interrogative (I) and has been bolded and underlined for emphasis. Any other suitable marker or markers can be used to flag discourse markers in a voice output.

In various embodiments, processing the voice output can include counting a first number of instances in which the user implements a positive communication repair strategy. Positive communication repair strategies can include instances where a speaker's reply gives the communication partner clarity as to as to what the speaker could not understand. In some embodiments, an instance in which the user implements a positive communication repair strategy is counted each time the system detects the user asking a specific question about what they could not hear could not hear or understand. For instance, upon detecting the voice output given by the ear-wearable device user in the example of FIG. 13 (e.g., where the user specifically asks, “Where are you going?”), the ear-wearable device system would count an instance of a positive communication repair strategy.

In various embodiments, positive communication repair strategies can be found in other aspects of the speaker's voice output such as vocal pitch and vocal tone, speech cadence, word patterns, word frequencies, or the like. For example, instances in which the user implements positive communication repair strategies can be counted each time the system detects the user speaking with clear diction, at an appropriate volume, or the like.

In various embodiments, processing the voice output can include counting a second number of instances in which the user implements a negative communication repair strategy. Negative communication repair strategies can include instances where a speaker's reply does not give the communication partner clarity as to as to what the speaker could not understand. In some embodiments, an instance in which the user implements a negative communication repair strategy is counted each time the user indicates that the they cannot hear without further explanation (e.g., just saying “What?”). For instance, upon detecting the voice output given by the ear-wearable device user in the example of FIG. 12 (e.g., where the user replies with the phrase “What?”), the ear-wearable device system would count an instance of a negative communication repair strategy.

In various embodiments, negative communication repair strategies can be found in other aspects of the speaker's voice output such as vocal pitch and vocal tone, speech cadence, word patterns, word frequencies, or the like. For example, instances in which the user implements negative communication repair strategies can be counted each time the system detects the user speaking with unclear diction, using an aggressive tone, or the like.

In various embodiments, the ear-wearable device can be configured to detect words in the voice output and classify at least one of the words as a question word of a plurality question words. In the example of FIG. 16, the phrase “what” has been classified as an interrogative (I), which can be counted as a question word.

In various embodiments, counting an instance in which the user implements a negative communication repair strategy can include detecting both the user uttering at least one of the plurality of question words in the voice output and the total number of words uttered in the voice output, other than the plurality of question words, being less than a threshold. In some embodiments, the threshold can be less than or equal to three words, two words, or one word, or can be an amount falling within a range between any of the foregoing. For instance, upon detecting the voice output of the phrase “what?,” the ear-wearable device system will count one question word and zero total words other than the plurality of question words. The ear-wearable device system will then count an instance of a negative communication repair strategy.

In various embodiments, counting an instance in which the user implements a positive communication repair strategy can include detecting both the user uttering at least one of the plurality of question words in the voice output and the total number of words uttered in the voice output, other than the plurality of question words, being greater than or equal to than the threshold. For instance, upon detecting the voice output of the phrase “where are you going?,” the ear-wearable device system will count one question word and three total words other than the plurality of question words. In embodiments, where the threshold is three words or less, the ear-wearable device system will then count an instance of a positive communication repair strategy.

In various embodiments, the ear-wearable device can be configured to detect lexical units in the voice output and classify at least one of the lexical units as a discourse marker of a plurality of discourse markers. In the example of FIG. 16, the phrase “what” has been classified as an interrogative (I), which can be counted as a discourse marker.

In various embodiments, counting an instance in which the user implements a negative communication repair strategy can include detecting the conditions of the user uttering at least one of the plurality of discourse markers in the voice output along with at least one of the number of lexical units uttered in the voice output other than the discourse markers being less than a threshold and/or a classification of the lexical units uttered during the voice output including a unit of speech that does not align with a type of information indicated by the discourse markers. In some embodiments, the threshold can be less than or equal to three lexical units, two lexical units, or one lexical unit, or can be an amount falling within a range between any of the foregoing. For instance, upon detecting the voice output of the phrase “what?,” the ear-wearable device system will count one discourse marker and zero total lexical units other than the discourse markers. The ear-wearable device system will then count an instance of a negative communication repair strategy.

Instacnes in which a unit of speech that does not align with a type of information indicated by the discourse markers can occur when an individual mishears a statement and replies with an “out of place” type of question or statement (e.g., replying “Oh, you're going to visit your mother in Michigan? Tell her I said hi!” to the statement “I'm going to visit my brother in Michigan tomorrow.”) Such a situation can be an example of a negative repair strategy because instead of seeking proper clarification on what they could not hear, the individual has made incorrect assumptions and replied with a confusing statement.

In various embodiments, counting an instance in which the user implements a positive communication repair strategy can include detecting both the user uttering at least one of the plurality of discourse markers in the voice output and the total number of lexical units uttered in the voice output, other than the plurality of discourse markers, being greater than or equal to than the threshold. For instance, upon detecting the voice output of the phrase “where are you going?”, the ear-wearable device system will count one discourse maker and three total lexical units other than the plurality of discourse markers. In embodiments, where the threshold is three lexical units or less, the ear-wearable device system will then count an instance of a positive communication repair strategy.

In various embodiments, the ear-wearable device system can be further configured to prompt the communication partner to evaluate the communication repair strategies implemented by the ear-wearable device user in the voice output. For instance, a rendering at the display 406 of the accessory device 204 can prompt the communication partner to rate the ear-wearable device user's communication strategies out of ten, give a “thumbs up” or “thumbs down” rating of the ear-wearable device user's communication strategies, or the like. In various embodiments, upon receiving a positive evaluation from the communication partner, the ear-wearable device system will count an instance of a positive communication repair strategy. In various embodiments, upon receiving a negative evaluation from the communication partner, the ear-wearable device system will count an instance of a negative communication repair strategy.

Referring now to FIG. 17, a schematic view of an accessory device including a user interface showing feedback regarding communication strategies is shown in accordance with various embodiments herein. In various embodiments, the ear-wearable device system can be configured to generate feedback indicative of the first number of instances (of positive communication repair strategies), the second number of instances (of negative communication repair strategies), or both the first number of instances and the second number of instances. In various embodiments, the ear-wearable device system can generate the prompt visually, audibly, or thought a combination thereof.

In the example of FIG. 17, the accessory device 204 displays a rendering of the number of positive communication repair strategies and the number of negative communication strategies a user has implemented over a given time frame. In some embodiments, the given time frame can be the course of a conversation between the ear-wearable device user and their communication partner. In some embodiments, the given time frame can be a time frame of pretermitted length such as one minute, five minutes, one hour, one day, or longer.

In various embodiments, the ear-wearable device system can be further configured to monitor trends in the first number of instances and/or the second number of instances over a predetermined time frame. The predetermined time frame can be any suitable time frame such as a day, a week, a month, a year, longer. For instance, the ear-wearable device system can be configured to count the first number of instances and the second number of instances every day for the course of a year. In such an embodiment, an ear-wearable device user can monitor their progress in implementing positive communication repair strategies over the course of a year. In some embodiments, comparing trends prior to and after a particular time or event (e.g., a communication repair strategy training session) can be used to evaluate the effectiveness of a therapeutic intervention.

### Communication Repair Strategy Simulations (FIG. 18)

Referring now to FIG. 18, a schematic view of a user interface on an accessory device 204 for communication repair strategy simulation is shown in accordance with various embodiments herein. In various embodiments, the ear-wearable device system can be configured to deliver a predetermined audible prompt or text to the user. In such an embodiment, the voice output monitored by the ear-wearable device system can be a response to the predetermined audible prompt.

In the example of FIG. 18, an example of a communication strategy exercise is rendered on the display 406 of the accessory device. In various embodiments, such a communication strategy exercise can be accessed by interacting with the user input button 1420 titled “Practice Exercises” on the main menu 1414 shown in FIG. 14. In various embodiments, the communication strategy exercise can include a prompt 1802. In the example of FIG. 18, the prompt 1802 is displayed on the display 406 of the accessory device 204. Additionally, or alternatively, the prompt can be delivered audibly to the ear-wearable device user. In some embodiments, the system may present the prompt 1802 with portion(s) of the text and/or audio purposefully obscured. In the example of FIG. 18 the word “Michigan” is obscured from the phrase “I'm going to visit my brother in Michigan tomorrow.”

In various embodiments, the ear-wearable device system is configured to present a plurality of options of communication repair strategies to respond to the prompt 1802. In various embodiments, the ear-wearable device system is configured to generate at least one example response to the prompt. In various embodiments, at least one of the example responses is an example of a positive communication repair strategy. In the example of FIG. 18, the display device shows four example responses 1804 on the display 406. To reply to the prompt, the ear-wearable device user can tap a selected example response on the display screen. Additionally, or alternatively, the user can speak their response into a microphone of the ear-wearable device system.

In the example of FIG. 18, the word “Michigan” is obscured from the phrase “I'm going to visit my brother in Michigan tomorrow.” The user is tasked with appropriately seeking clarification to the prompt. The ear-wearable device system can then score or provide feedback to the user based on the response they input. In various embodiments, higher scoring responses correspond to responses that implement positive communication repair strategies and lower scoring responses correspond to responses that implement negative communication repair strategies.

In the context of FIG. 18, a higher scoring response implements positive communication repair strategies to obtain the missing information from the prompt. In this case, the user needs to find out where the speaker is going to visit their brother. The first selectable reply, “What?,” would be a lower scoring response. As detailed above, simply replying with a question word and not clarification is an example of a negative communication repair strategy. The third selectable reply, “Who are you visiting?” would also be a lower scoring response because this response asks for the wrong piece of information (who this speaker is visiting rather than where they are going). The second selectable reply, “Where are you going?” would be a higher scoring response. This response uses positive communication repair strategies to obtain the specific piece of information missing from the prompt.

In some embodiments, the user may also input their own custom response to the prompt. The ear-wearable device system can score the custom response using text and/or language analysis.

In some other embodiments, the ear-wearable device system is configured to facilitate a simulated conversation between a user and the ear-wearable device system. In some embodiments, the system may synthesize or present prerecorded speech utterances to the user and monitor the user's responding voice output. The synthesized or prerecorded speech samples may be processed to obscure, distort, mute, diminish, or otherwise mask certain parts of the utterances such that the user may need to use communication repair strategies to seek clarification. It should be appreciated that various types of masking can be employed, such as energetic masking and/or informational masking. Energetic masking involves adding competing noise (e.g., white noise, pink noise, speech-shaped noise, etc.) that reduces the SNR, whereas informational masking involves competing noise that purposefully causes linguistic confusions (uncertainty) between the target sound source signal and extraneous sound source masker.

In some embodiment, the ear-wearable device system can utilize natural language/speech recognition, large language models, and artificial intelligence to process the user's responses and carry out the role playing in a natural conversational manner. For instance, the ear-wearable device system can be configured to respond to the user's communication and evolve the conversation to present more opportunities for the user to practice utilizing communication repair strategies.

Communication strategy exercises can also be beneficial to the communication partners of ear-wearable device users. In some embodiments, the ear-wearable device system is configured to synthesize or present prerecorded speech utterances to the communication partner that simulate the effects of hearing loss. In some embodiments, the hearing loss can be simulated by one or more of frequency filtering, signal degradation, spectral smearing, peak clipping, distortion, non-linear loudness growth, or the like. The hearing loss simulation may be generic or customized to reflect the degree, patterns, or characteristics of a specific individual's hearing loss. Such a simulation can educate communication partners on the effects of hearing loss and motivate them to utilize positive communication strategies and clear speech when communicating with individuals with hearing impairment.

### Feedback and Demonstration Regarding Speech Clarity and User Profile Parameters

It may be difficult for communication partners to understand or appreciate the impact that their own speech patterns may have on the speech understanding of someone with hearing difficulty (e.g., an ear-wearable device user). Accordingly, it is desirable to provide education to ear-wearable device users and their communication partners. In particular, it can be desirable to demonstrate the effect that speech rate and clear speech techniques have on listening effort.

A system and method of providing guidance regarding communication strategies and repair to an ear-wearable device user and/or their communication partner can be provided. Such a method can be executed in a processor of a feedback system having a microphone and a memory storage. In various embodiments, the method can include receiving an input audio signal at the microphone. In some embodiments, the input audio signal can include a voice signal. In various embodiments, the method can include calculating a speech rate of the voice signal. In various embodiments, the method can include comparing the calculated speech rate to a user-profile speech rate, wherein the user-profile speech rate is stored in a user profile. In various embodiments, the method can include generating feedback indicative of the calculated speech rate relative to the user-profile speech rate.

In various embodiments, the user-profile speech rate can be based on learned audio preferences of the user. In one example, the ear-wearable device system can be configured to learn the audio preferences of a user by playing the user a plurality of audio samples at different speech rates and prompting the user to select one or more preferred audio samples based on the speech rates the user can best understand. In various embodiments, the ear-wearable device system can be further configured to convey the user-profile speech rate to the communication partner of the user. In various embodiments, the user-profile speech rate can be determined by receiving user input selecting the user-profile speech rate.

In various embodiments, the ear-wearable device system may calculate or score the typical speech rate of an individual based on any suitable techniques capable of determining the number of words spoken within a time frame, such as natural language processing. In some embodiments, the system may ask a user for a rating of perceived speech understanding associated with a given speech rate.

In various embodiments, the ear-wearable device system can determine that the calculated speech rate is faster than the user-profile speech rate and generate feedback providing an instruction to speak at a slower rate. In various embodiments, the ear-wearable device system can determine that the calculated speech rate is slower than the user-profile speech rate and generate feedback providing an instruction to speak at a faster rate. In various embodiments, generating the feedback includes providing visual feedback on the display 406 of the accessory device indicative of the calculated speech rate relative to the user-profile speech rate. In some embodiments, after providing feedback, the ear-wearable device system is configured to prompt the user to re-evaluate the communication partner's speech at the new speech rate.

In various embodiments, the ear-wearable device system can utilize a method of determining an ideal speech rate for a user, either using live speech from a communication partner or using pre-recorded speech. In various embodiments, the ear-wearable device system can generate a first playback of a recording of the voice signal and generate a second playback of the voice signal wherein the voice signal is altered to be at the user-profile speech rate. In some embodiments, a rate of ideal speech rate may be compared to a sample of contemporaneous “live” speech and provide feedback to a communication partner that indicates whether their rate of speech should be decreased or increased to optimize the understanding of the user with hearing difficulty.

In some embodiments, samples of degraded speech may be presented to the communication partner at various rates so that they can appreciate the effect that speech rate has on their own speech understanding. By artificially degrading speech using filters, distortion, background noise, spectral smearing, and the like, the ear-wearable device system may make the generated speech more difficult to understand for the communication partner. By allowing this communication partner to listen at different speech rates, they may come to appreciate the effect that slowed speech rates have on their brain's ability to decipher the degraded speech, which simulates the experiences of an individual with hearing impairment.

In various embodiments, the ear-wearable device system is configured to generate a first output audio signal with the speaker and a second output audio signal with the speaker. In various embodiments the first output audio signal can include a first voice signal processed with a first set of parameters. In various embodiments, the first set of parameters can be configured to simulate how an individual with substantially normal audio processing capabilities perceives the first voice signal. In various embodiments, the second output audio signal can include the first voice signal processed with a second set of parameters. In various embodiments, the second set of parameters can be configured to simulate how the user of the ear-wearable device perceives the first voice signal. In some embodiments, the second output audio signal is configured to simulate a hearing loss condition of the user of the ear-wearable device.

In various embodiments, the second output audio signal is generated at a baseline speech rate. In various embodiments, the ear-wearable device system is configured to generate the second output audio signal at a second speech rate, wherein the second speech rate is faster than the baseline speech rate. In various embodiments, the ear-wearable device system is configured to generate the second output audio signal at a third speech rate, wherein the third speech rate is slower than the baseline speech rate.

In various embodiments, the ear-wearable device system is configured to prompt the communication partner to rate the baseline speech rate, second speech rate, and third speech rate based on which speech rate the communication partner can best understand the second output audio signal. In various embodiments, the ear-wearable device system is configured to prompt the user of the ear-wearable device to rate the baseline speech rate, second speech rate, and third speech rate based on which speech rate the user can best understand the second output audio signal.

In various embodiments, the ear-wearable device system can include an accessory device configured to be held or worn by the communication partner, such as a smart watch, or the like. In various embodiments, the accessory device can include a haptic feedback mechanism. In various embodiments, the accessory device can generate haptic feedback (e.g., vibrations) to remind the communication partner to improve their communication (by speaking louder, more slowly, more clearly, etc.) when speaking with the ear-wearable device user.

### Visual Cues

It is well established that speech reading greatly improves speech understanding, for individuals with and without hearing impairments. However, the degree to which speech reading assists individuals with hearing impairments may be difficult for their communication partners to appreciate, and this frequently results in sub-optimal communication behaviors such as not facing an ear-wearable device user when speaking to them. Individuals with hearing impairment could also benefit from being more mindful of controlling their environment to optimize their ability to speech read. Accordingly, it is desirable to provide education to ear-wearable device users and their communication partners. In particular, it can be desirable to demonstrate the importance of visual cues.

A system and method of providing guidance regarding visual cues to an ear-wearable device user and/or their communication partner can be provided. Such a method can be executed in a processor of a feedback system having a microphone and a memory storage, and a display. In various embodiments, the method can include playing a first video segment using the display and the speaker. The first video segment can include a first visual output depicting a mouth of an orator speaking a first utterance. The first visual output having a first set of display parameters. The first video segment can include a first audio output including the first utterance. In various embodiments, the first audio output is played in synchronization with the mouth speaking the first utterance.

In various embodiments, the method can include playing a second video segment using the display and the speaker. The second video segment can include a second visual output depicting the mouth of the orator speaking a second utterance. The second visual output can have a second set of display parameters. The second video segment can include a second audio output including the second utterance, wherein the second audio output is played in synchronization with the mouth speaking the second utterance. In various embodiments, the method can include prompting a viewer of the display to select one of the first video segment or the second video segment based on in which the viewer can best understand the first utterance or the second utterance.

In various embodiments, the first utterance includes a first phrase and wherein the second utterance includes a variation of the first utterance. In various embodiments, the first utterance and the second utterance are of approximately equal length.

In various embodiments, the first set of display parameters are configured to clearly depict the mouth of the orator. In various embodiments, the second set of display parameters apply one or more distortions to the mouth of the orator. In various embodiments, the second set of display parameters are configured to at least partially obstruct the mouth of the orator. In various embodiments, the second set of display parameters are configured to improve a visibility or clarity of the mouth of the orator.

When positioned in front of the face of the talker, an accessory device (e.g., accessory device 204) naturally obscures access to visual cues. However, when the visual display faces outward, towards other individuals, the rear-facing cameras can be utilized to restore access to facial movements in near-real time. In various embodiments, the ear-wearable device system produces, using one or more cameras of the accessory device, demonstrations involving speech reading cues.

In some embodiments, the image signal of the accessory's camera(s) may be processed/modified to simulate various conditions. In some embodiments, the image signals may be altered to change the level of sharpness/blur, brightness/darkness, contrast, color, magnification, and the like. In some embodiments, an embedded light emitter of the accessory may be activated/adjusted to modify the visibility, brightness, contrast, color or like.

In some embodiments, facial feature detection may be utilized to selectively enhance, augment, or diminish specific facial movements and the like. In some embodiments, exaggerated facial feature shadow effects may be applied to simulate harsh lighting. In some embodiments, simulated backlighting may be applied to effectively reduce the brightness and/or contrast of facial cues while also simulating and increased brightness of light seemingly coming from behind the target talker. In some embodiments, simulated facial hair or masks may be applied to effectively reduce the visibility of the target talker's lips and/or mouth area. In some embodiments, facial feature detection may be used to calculate one or more facial feature movement scores and provide responsive feedback to communication partners on how to improve their facial expressions and the like for individuals who rely on those types of cues to understand their speech.

### Demonstration System for Ear-wearable Device Optimal Hearing Aid Features and Accessories Demo for Communication Partner

Ear-wearable device users and their communication partners may not intuitively understand how to optimize their use of ear-wearable device features ear-wearable device accessories. Audiologists generally offer new ear-wearable device users some instruction on ear-wearable device features and accessories. However, some users may not receive adequate instruction. Moreover, ear-wearable device users tend to forget their instruction over time. Accordingly, it can be beneficial to offer reinforced teaching methods outside of a clinical setting.

A system and method for providing information related to an ear-wearable device system to an ear-wearable device user and/or their communication partner can be provided. Such a method can be executed in a processor of an ear-wearable device system. In various embodiments, the ear-wearable device system can include an ear-wearable device having ear-wearable device speaker, an ear-wearable device microphone, and a memory storage. The ear-wearable device system can further include an accessory speaker outside of an ear-wearable device housing, and an accessory microphone.

In various embodiments, the method can include recording a first audio sample with the ear-wearable device microphone. The first audio sample can include a first target stimuli. In various embodiments, the method can include recording a second audio sample with the accessory microphone. The second audio sample can include a second target stimuli. In various embodiments, the method can include playing the first audio sample and the second audio sample at the accessory speaker or at the ear-wearable device speaker.

Referring now to FIG. 19, a schematic view of an ear-wearable device user and communication partner utilizing an ear-wearable device system is shown in accordance with various embodiments herein. FIG. 19 depicts an ear-wearable device user 508 with their communication partner 1202. The ear-wearable device user can be wearing a single ear-wearable device 100 or a pair of ear-wearable devices 100, 200. The ear-wearable device user 508 and/or the communication partner 1202 can engage with an accessory device 204. In some embodiments, the ear-wearable device user 508 and the communication partner 1202 can engage with the same accessory device 204. In some embodiments, the ear-wearable device user 508 and the communication partner 1202 can each engage with their own accessory device 204.

In various embodiments, the ear-wearable device system can further include an accessory microphone 1902. An accessory microphone (also known as a remote microphone) as defined herein is a microphone (or array of microphones) that is physically separate from the ear-wearable device(s) and is configured to pick up sound from the acoustic environment and transmit the sound directly to the ear-wearable device(s). In the example of FIG. 19, the accessory microphone 1902 is external to the accessory device 204. Alternatively, the accessory microphone can be integrated int the accessory device 204. Examples of accessory microphones can include but are not limited to tabletop microphones, pen microphones, clip-on microphones, neck-worn loop systems, integrated microphone systems in other devices (e.g., audio streamers, mobile devices), or the like. In various embodiments, the ear-wearable device system can include one, two, three, or more accessory microphones.

In various embodiments an accessory microphone 1902 can be placed adjacent to a target sound source. In the event where an accessory microphone is closer to the target sound source than the ear-wearable device(s), the SNR at the accessory microphone can be substantially higher than the SNR at the microphone of the ear-wearable device(s).

Despite their benefits, many ear-wearable device users and communication partners either do not utilize accessory microphones or use their accessory microphones sub optimally. This is often because accessory microphones are customarily, but not necessarily, sold separately from the ear-wearable device(s). It is often also true that accessory microphone devices need to be charged and maintained separately from ear-wearable devices, so ear-wearable device users and their communication partners may not feel motivated to perform those tasks or carry the additional accessory microphone with them when their use of it is sporadic. Therefore, it would be beneficial to provide ear-wearable device wearers and their communication partners with experiences demonstrating, simulating, and/or approximating the benefits of accessory microphones in order to motivate them to purchase the accessory microphone and have it ready to use in scenarios where the accessory microphone would be beneficial.

Lewis and colleagues (2004) demonstrated as much as a 23 dB SNR improvement in their test conditions when using an accessory microphone with ear-wearable devices compared to ear-wearable devices with omni-directional microphones alone. The remarkable SNR benefit provided through use of accessory microphones is greatly diminished by sub-optimal user behavior (e.g., moving the accessory microphone further from the target sound source). Indeed, Burwinkel and colleagues (2024) found that the effective SNR benefit provided through public assistive listening systems at real-world city council meetings varied from 30 dB, with optimal input microphone placement, to a mere 5 dB, with sub-optimal input microphone configuration. Therefore, it would be beneficial for ear-wearable device users and their communication partners to gain an internalized appreciation for the effect that accessory microphone placement has on the subsequent benefit thereof. Accordingly, an ear-wearable device system configured to train ear-wearable device users and their communication partners to make optimal use of accessory microphones is provided herein.

### User Interface for Accessory Device Control (FIG. 20)

Referring now to FIG. 20, a schematic view of an accessory device 204 including a user interface to facilitate accessory device control and demonstration is shown in accordance with various embodiments herein. The accessory device 204 can include a display 406. In some embodiments, the accessory device 204 can also include a camera 410, a speaker 408, and a microphone (not shown).

In the example of FIG. 20, the display 406 of the accessory device 204 is displaying a main menu 2014 for an ear-wearable device system. In various embodiments, the menu 2014 include a plurality of user input buttons (2016, 2018, 2020, 2022, 2024). In various embodiments, when the user interacts with one of plurality of user input buttons (e.g., by tapping the display 406), the user is directed to a corresponding rendering generated by the accessory device 204.

In various embodiments, the main menu 2014 can include a user input button 2016 for settings and accessory tips. In various embodiments, upon selecting the user input button 2016, the user is directed towards a page containing guidance on optimally utilizing ear-wearable device settings and accessories. Such guidance can include optimal ear-wearable device settings for different scenarios (e.g., a crowded restaurant or a movie theater), advice on how to position an accessory microphone, or the like.

In various embodiments, the main menu 2014 can include a user input button 2018 for accessory and settings demonstrations. In various embodiments, upon selecting the user input button 2018, the ear-wearable device system can demonstrate the impact of hearing aid settings and accessories on sound quality. For instance, the ear-wearable device system can simulate sound quality of a voice signal in a crowded environment using just the ear-wearable device microphones compared to using an accessory microphone.

In various embodiments, the main menu 2014 can include a user input button 2020 for practice exercises. In various embodiments, upon selecting the user input button 2020, the user is directed towards a page containing practice exercises. Such practice exercises can include choosing the optimal ear-wearable device settings and/or accessories for a given scenario.

In various embodiments, the main menu 2014 can include a user input button 2022 for user data. In various embodiments, upon selecting the user input button 2022, the user is directed towards a page containing user data. Such data can include performance on practice exercises, preferred ear-wearable device settings, or the like.

In various embodiments, the main menu 2014 can include a user input button 2024 for user settings. In various embodiments, upon selecting the user input button 2024, the user is directed towards a page containing user settings. The user settings can include settings for the ear-wearable device(s) and/or the accessory device. Such settings can include volume settings, muting on/off, frequency settings, triggering a particular functionality, telecoil/hearing loop settings, wireless settings, noise reduction settings, directional microphone settings, or the like.

The main menu 2014 depicted by FIG. 20 is for exemplary purposes only. In various embodiments, the main menu can include any suitable combination of user input buttons displayed in any suitable arrangement.

### Accessory Microphone Demonstration (FIGS. 21-23)

In various embodiments, the ear-wearable device system is configured to demonstrate accessory microphone technology to an ear-wearable device user and/or their communication partner. In various embodiments, the ear-wearable device user and/or the communication partner can initiate a demonstration by interacting with the accessory device 204 (e.g., by selecting the user input button 2018 titled “Accessory/Setting Demo.”)

In various embodiments, the ear-wearable device system is configured to record a first audio sample with the ear-wearable device microphone. The first audio sample can come from any suitable source. In some embodiments, the first audio sample can be a voice signal from the ear-wearable device user and/or their communication partner. In some embodiments, the first audio signal can be generated by the ear-wearable system (e.g., at the speaker 408 of the accessory device 204). In various embodiments, the first audio sample can include a first target stimuli. The first target stimuli can be any suitable stimuli such as words spoken by the communication partner, or the like. For example, the phrases “Let's go to lunch” or “Slippery spot ahead” could be target stimuli.

In various embodiments, the first audio sample can be streamed from ear-wearable devices 100, 200 to the accessory device 204 using any suitable communication protocol (e.g., Bluetooth Low Energy, 900 MHz, mesh networks, etc.). The streamed audio signals can then be stored in a memory of the accessory device.

In various embodiments, the ear-wearable device system is configured to record a second audio sample with the accessory microphone. The second audio sample can be the same as or different from the first audio sample. In some embodiments, the second audio sample is recorded before or after the first audio sample. In some embodiments, first audio sample and the second audio sample are recorded simultaneously. In various embodiments, the second audio sample can include a second target stimuli. The second target stimuli can be the same as or different from the first target stimuli.

In some embodiments, the ear-wearable device system is configured to synchronize the second audio sample recorded with the accessory microphone with the first audio sample recorded with the ear-wearable device microphone to create a composite audio sample. In some embodiments, the composite audio sample can be saved in the memory of the accessory device.

In some embodiments, the communication partner is also wearing one or more ear-wearable devices. In such embodiments, the ear-wearable device system is configured to record an additional audio sample with a microphone of the communication partner's ear-wearable device(s). In some embodiments, the additional audio sample can be saved in the memory of the accessory device.

Additionally, or alternatively to recording the audio samples, the ear-wearable device system can include a plurality of existing audio samples stored in a memory. The existing audio samples can include at least a first audio sample configured to simulate a first target stimuli being recorded with an ear-wearable device microphone. The existing audio samples can include at least a second audio sample configured to simulate a second target stimuli being recorded with an accessory microphone. In various embodiments, the existing audio samples are pre-recorded audio samples. In various embodiments, the existing audio samples come pre-installed in the ear-wearable device system.

In various embodiments, the ear-wearable device system is configured to play the first audio sample and the second audio sample. In some embodiments, the second audio sample is automatically played after the first audio sample. In some embodiments, the first and second audio samples are played at an accessory speaker (e.g., speaker 408 of accessory device 204). Additionally, or alternatively, the first and second audio samples are played at a speaker of the ear-wearable device(s).

In various embodiments, the audio samples can be played without additional processing. In some embodiments, the ear-wearable device system is configured to normalize the audio samples before playing them. In some embodiments, the ear-wearable device system is configured to further modify the audio samples by simulating one or more signal processing features, providing added emphasis of an effect, simulating the effects of sub-optimal user behavior, or the like.

Referring now to FIG. 21, a schematic view of an accessory device 204 including a user interface for rendering a selection of audio samples is shown in accordance with various embodiments herein. In this example, a selection of audio samples is rendered on the display 406 of the accessory device 204. In various embodiments, the ear-wearable device system is configured to display a visual representation of the first audio sample and the second audio sample. In various embodiments, the ear-wearable device system is configured to display a visual representation of three or more audio samples. In some embodiments, the ear-wearable device user and/or the communication partner can interact with the accessory device 204 to selectively play one or more audio samples. In the example of FIG. 21, the ear-wearable device user and/or the communication partner can tap any of “play first audio sample,” “play second audio sample,” and “play third audio sample,” on the display 406 of the accessory device 204 to play a corresponding audio sample.

In various embodiments, the ear-wearable device system is configured to prompt a user input selection of in which of the audio samples the target stimuli is most understandable to the user. In various embodiments, the ear-wearable device system is configured to prompt a user input selection of in which of the plurality of audio samples the target stimuli is most understandable on the accessory device 204. In some embodiments, where the target stimuli includes a voice signal, the ear-wearable device system is configured to prompt a user input selection of in which of the audio samples the voice signal is most understandable.

In the example of FIG. 21, a selection of audio samples is rendered on the display 406 of the accessory device. In some embodiments, the ear-wearable device user and/or the communication partner can interact with the accessory device 204 to select which of the plurality of audio samples they could best understand the target stimuli. For instance, the ear-wearable device user and/or the communication partner can tap any of “first audio sample,” “second audio sample,” and “third audio sample,” under the prompt “Which audio sample was the easiest to understand?”

In various embodiments, the ear-wearable device system is configured to simulate how location, distance, relative proximities, orientation, processing parameters, or the like can impact the sound quality generated by an accessory microphone.

Referring now to FIG. 22, a schematic view of an ear-wearable device user and communication partner utilizing an ear-wearable device system is shown in accordance with various embodiments herein. The scenario depicted by FIG. 22 is configured to depict an example demonstration of how the location of the accessory microphone 1902 impacts audio quality.

In various embodiments, the ear-wearable device system is configured to record audio samples with the accessory microphone at different locations. Each recorded audio sample can contain a target stimuli. In various embodiments, the accessory microphone 1902 can be at a first location to record a first audio sample. The accessory microphone 1902 can then be moved to a second location to record a second audio sample. In the example of FIG. 22, the accessory microphone 1902 is moved from location L1 to location L2. In various embodiments, the accessory microphone can record audio samples in any suitable number of locations such as two, three, four, or more locations.

In various embodiments, the ear-wearable device system is configured to play each of the audio samples. In the example of FIG. 22, the ear-wearable device system is configured to play the first audio sample taken with the accessory microphone 1902 at location L1 and the second audio sample taken with the accessory microphone 1902 at location L2.

In various embodiments, the ear-wearable device system is configured to prompt a user input selection of in which audio sample the target stimuli is the most understandable. In the example of FIG. 22, the second location L2 is closer to the communication partner 1202 (but further from the ear-wearable device user 508) than the first location L1. In this example, if the target stimuli is the voice of the communication partner 1202, the ear-wearable device user and the communication partner will likely find the audio sample taken with the accessory microphone 1902 at the second location L2 easier to understand than the audio sample taken with the accessory microphone 1902 at the first location L1. Conversely, if the target stimuli is closer to the ear-wearable device user 508 than the communication partner 1202, the ear-wearable device user and the communication partner will likely find the audio sample taken with the accessory microphone 1902 at the second location L2 more difficult to understand than the audio sample taken with the accessory microphone 1902 at the first location L1.

The demonstration exemplified by FIG. 22 is configured to educate the ear-wearable device user and their communication partner of the importance of positioning an accessory microphone close to the target sound source.

Referring now to FIG. 23, a schematic view of an ear-wearable device user and communication partner utilizing an ear-wearable device system is shown in accordance with various embodiments herein. The scenario depicted by FIG. 23 is configured to depict an example demonstration of how the orientation of the accessory microphone 1902 impacts audio quality.

In various embodiments, the ear-wearable device system is configured to record audio samples with the accessory microphone at different orientations. Each recorded audio sample can contain a target stimuli. In various embodiments, the accessory microphone 1902 can be facing a first direction to record a first audio sample. The accessory microphone 1902 can then be turned to a second direction to record a second audio sample. In the example of FIG. 22, the accessory microphone 1902 is rotated from orientation D1 to orientation D2. In various embodiments, the accessory microphone can record audio samples in any suitable number of orientations such as two, three, four, or more orientations.

In various embodiments, the ear-wearable device system is configured to play each of the audio samples. In the example of FIG. 23, the ear-wearable device system is configured to play the first audio sample taken with the accessory microphone 1902 at direction D1 and the second audio sample taken with the accessory microphone at direction D2.

In various embodies, the ear-wearable device system is configured to prompt a user input selection of in which audio sample the target stimuli is the most understandable. In embodiments, where the accessory microphone 1902 is a directional microphone, the orientation of the accessory microphone is of particular importance. In the example of FIG. 23, the accessory microphone 1902 can be a directional microphone having a beam 2302 orientated at the top of the curved portion of the microphone.

In the example of FIG. 23, the beam 2302 is facing upwards when the accessory microphone 1902 is orientated in the first direction D1 and the beam 2302 is facing towards the communication partner 1202 when the accessory microphone 1902 is orientated in the second direction D2. In this example, if the target stimuli is the voice of the communication partner 1202, the ear-wearable device user and the communication partner will likely find the audio sample taken with the accessory microphone oriented in the second direction D2 easier to understand than the audio sample taken with the accessory microphone oriented in the first direction D1. Conversely, if the target stimuli is closer to the ear-wearable device user 508 than the communication partner 1202, the ear-wearable device user and the communication partner will likely find the audio sample taken with the accessory microphone oriented in the second direction D2 more difficult to understand than the audio sample taken with the accessory microphone oriented in the first direction D1.

The demonstration exemplified by FIG. 23 is configured to educate the ear-wearable device user and their communication partner regarding the importance of orientating the accessory microphone towards the target sound source. In particular, if the accessory microphone is directional, the beam of the microphone should be facing towards the target sound source.

Referring now to FIG. 24, a schematic view of an ear-wearable device user and communication partner utilizing an ear-wearable device system is shown in accordance with various embodiments herein. The scenario depicted by FIG. 24 is configured to depict an example demonstration of how the location of the accessory microphone 1902 impacts audio quality.

In various embodiments, the ear-wearable device system is configured to record audio samples with the accessory microphone at different locations. Each recorded audio sample can contain a target stimuli. In various embodiments, the target stimuli is the voice of the communication partner 1202. In various embodiments, an extraneous sound source can be introduced into the demonstration. In the example of FIG. 24, a second accessory device 2401 is configured to generate background noise. However, any other suitable sound source can be introduced into the demonstration.

In various embodiments, the accessory microphone 1902 can be at a first location to record a first audio sample. The accessory microphone 1902 can then be moved to a second location to record a second audio sample. In the example of FIG. 24, the accessory microphone 1902 is moved from location L1 to location L2. In various embodiments, the accessory microphone can record audio samples in any suitable number of locations such as two, three, four, or more locations. In various embodiments, the accessory microphone can record audio samples in any suitable number of directions such as two, three, four, or more directions.

In various embodiments, the ear-wearable device system is configured to play each of the audio samples. In the example of FIG. 22, the ear-wearable device system is configured to play the first audio sample taken with the accessory microphone 1902 at location L1 and the second audio sample taken with the accessory microphone 1902 at location L2.

In various embodiments, the ear-wearable device system is configured to prompt a user input selection of in which audio sample the target stimuli is the most understandable. In the example of FIG. 24, the second location L2 is further away from the extraneous sound source (the background noise generated by the second accessory device 2401) than the first location L1. In this example, the ear-wearable device user and the communication partner will likely find the audio sample taken with the accessory microphone 1902 at the second location L2 easier to understand than the audio sample taken with the accessory microphone 1902 at the first location L1 due to the accessory microphone being further away from the extraneous sound source at location L2.

The demonstration exemplified by FIG. 24 is configured to educate the ear-wearable device user and their communication partner regarding the importance of positioning the accessory microphone away from extraneous sound sources.

In various embodiments, the ear-wearable device system is further configured to demonstrate how processing parameters impact the audio quality of an accessory microphone. In various embodiments, the ear-wearable device system is configured to record audio samples with the accessory microphone using different sets of processing parameters. Each recorded audio sample can contain a target stimuli. In various embodiments, the accessory microphone 1902 use a first set of processing parameters to record a first audio sample. The accessory microphone 1902 can use a second set of processing parameters to record a second audio sample. In various embodiments, the accessory microphone can record audio samples with any suitable number of different processing parameters such as two, three four, or more processing parameters. Additionally, or alternatively, the ear wearable device system can record a single audio sample and create multiple versions of the audio sample using different sets of processing parameters.

In various embodiments, the ear-wearable device system is configured to play each of the audio samples. For instance, the ear-wearable device system is configured to play the first audio sample recorded with the first set of processing parameters and the second audio sample recorded with the first set of processing parameters.

In various embodies, the ear-wearable device system is configured to prompt a user input selection of in which audio sample the target stimuli is the most understandable.

Examples of processing parameters that the ear-wearable device system can implement on the audio sample(s) includes various degrees of or techniques for speech enhancement, noise reduction, acoustic feedback suppression, frequency shifting, frequency lowering, frequency compression, or frequency transposition, various degrees of directionality and beamforming, various audio level mix ratios of accessory microphone and hearing aid microphone input, or the like.

### User Experience and Feature Demonstration

It is often useful for ear-wearable device users and their communication partners to understand the capabilities and limitations of ear-wearable devices. In various embodiments, demonstrating ear-wearable device features can help ear-wearable device users and their communication partners to appreciate the value of ear-wearable devices as well as the effects of sub-optimal utilization of ear-wearable devices.

A system and method for providing information related to an ear-wearable device system to an ear-wearable device user and/or their communication partner can be provided. Such a method can be executed in a processor of an ear-wearable device system. In various embodiments, the ear-wearable device system can include an ear-wearable device having ear-wearable device speaker, an ear-wearable device microphone, and a memory storage. The ear-wearable device system can further include an accessory speaker outside of an ear-wearable device housing, and an accessory microphone.

In various embodiments, the method can include playing a first audio sample at the accessory speaker. The first audio sample can include an audio recording having a target stimuli and can be processed with a first set of ear-wearable device parameters. In various embodiments, the method can include playing a second audio sample at the accessory speaker. The second audio sample can include the audio having the target stimuli recording processed with a second set of ear-wearable device parameters.

In various embodiments, the first audio sample is configured to simulate a first hearing profile, and the second audio sample is configured to simulate a second hearing profile. In various embodiments, the first hearing profile is configured to simulate normal hearing, and the second hearing profile is configured to simulate impaired hearing.

In various embodiments, a user profile comprises user parameters for the ear-wearable device for addressing a hearing impairment of the user. In various embodiments, the second ear-wearable device parameters comprise the user parameters.

In various embodiments, the first set of ear-wearable device parameters are configured to provide a first setting of noise reduction to the audio recording and the second set of ear-wearable device parameters are configured to provide a second setting of noise reduction to the audio recording. In various embodiments, the first set of ear-wearable device parameters are configured to provide a first setting of feedback suppression to the audio recording and the second set of ear-wearable device parameters are configured to provide a second setting of feedback suppression to the audio recording. In various embodiments, the first set of ear-wearable device parameters are configured to provide a first setting of speech enhancement to the audio recording and the second set of ear-wearable device parameters are configured to provide a second setting of speech enhancement to the audio recording. In various embodiments, the first set of ear-wearable device parameters are configured to simulate a hearing aid microphone input, and the second set of ear-wearable device parameters are configured to are configured to simulate an accessory microphone input.

In various embodiments, the hearing aid microphone includes a directional microphone. In various embodiments, the first set of ear-wearable device parameters are configured to simulate a first microphone having a first directionality, and the second set of ear-wearable device parameters are configured to a second microphone having a second directionality.

### Ear-Wearable Device Components (FIG. 25)

Referring now to FIG. 25, a schematic block diagram of components of an ear-wearable device is shown in accordance with various embodiments herein. The block diagram of FIG. 25 represents a generic ear-wearable device for purposes of illustration. The ear-wearable device 100 shown in FIG. 25 includes several components electrically connected to a flexible mother circuit 2418 (e.g., flexible mother board) which is disposed within housing 2400. A power supply circuit 2404 can include a battery and can be electrically connected to the flexible mother circuit 2418 and provides power to the various components of the ear-wearable device 100. One or more microphones 2406 are electrically connected to the flexible mother circuit 2418, which provides electrical communication between the microphones 2406 and a digital signal processor (DSP) 2412. Among other components, the DSP 2412 incorporates or is coupled to audio signal processing circuitry configured to implement various functions described herein. DSP 2412 can selectively perform mathematical calculations and/or apply relative weightings to the signals of the one or more microphones 2406 to produce varying degrees of microphone array directivity or polar patterns. A sensor package 2414 can be coupled to the DSP 2412 via the flexible mother circuit 2418. The sensor package 2414 can include one or more different specific types of sensors such as those described in greater detail below. One or more user switches 2410 (e.g., on/off, volume, mic directional settings) are electrically coupled to the DSP 2412 via the flexible mother circuit 2418.

An audio output device 2416 is electrically connected to the DSP 2412 via the flexible mother circuit 2418. In some embodiments, the audio output device 2416 comprises an electroacoustic transducer or speaker (coupled to an amplifier). In other embodiments, the audio output device 2416 comprises an amplifier coupled to an external receiver 2420 adapted for positioning within an ear of a wearer. The external receiver 2420 can include an electroacoustic transducer, speaker, or loudspeaker. The ear-wearable device 100 may incorporate a communication device 2408 coupled to the flexible mother circuit 2418 and to an antenna 2402 directly or indirectly via the flexible mother circuit 2418. The communication device 2408 can be a BLUETOOTH® transceiver, such as a BLE (BLUETOOTH® low energy) transceiver or other transceiver(s) (e.g., an IEEE 802.11 compliant device). The communication device 2408 can be configured to communicate with one or more external devices, such as those discussed previously, in accordance with various embodiments. In various embodiments, the communication device 2408 can be configured to communicate with an external visual display device such as a smart phone, a video display screen, a tablet, a computer, or the like.

In various embodiments, the ear-wearable device 100 can also include a control circuit 2422 and a memory storage device 2424. The control circuit 2422 can be in electrical communication with other components of the device. In some embodiments, a clock circuit 2426 can be in electrical communication with the control circuit. The control circuit 2422 can execute various operations, such as those described herein. The control circuit 2422 can include various components including, but not limited to, a microprocessor, a microcontroller, an FPGA (field-programmable gate array) processing device, an ASIC (application specific integrated circuit), or the like. The memory storage device 2424 can include both volatile and non-volatile memory. The memory storage device 2424 can include ROM, RAM, flash memory, EEPROM, SSD devices, NAND chips, and the like. The memory storage device 2424 can be used to store data from sensors as described herein and/or processed data generated using data from sensors as described herein.

It will be appreciated that various of the components described in FIG. 25 can be associated with separate devices and/or accessory devices to the ear-wearable device. By way of example, microphones can be associated with separate devices and/or accessory devices. Similarly, audio output devices can be associated with separate devices and/or accessory devices to the ear-wearable device.

Accessory devices herein can include various different components. In some embodiments, the accessory device 204 can be a personal communications device, such as a smart phone. However, the accessory device can also be other things such as a wearable device, a handheld computing device, a dedicated location determining device (such as a handheld GPS unit), smart watch, or the like.

### Accessory Device Components (FIG. 26)

Referring now to FIG. 26, a schematic block diagram of components of an accessory device 204 is shown in accordance with various embodiments herein. This block diagram is just provided by way of illustration, and it will be appreciated that accessory devices can include greater or lesser numbers of components. The accessory device in this example can include a control circuit 2502. The control circuit 2502 can include various components which may or may not be integrated. In various embodiments, the control circuit 2502 can include a microprocessor 2506, which could also be a microcontroller, FPGA, ASIC, or the like. The control circuit 2502 can also include a multi-mode modem circuit 2504 which can provide communications capability via various wired and wireless standards. The control circuit 2502 can include various peripheral controllers 2508. The control circuit 2502 can also include various sensors/sensor circuits 2532. The control circuit 2502 can also include a graphics circuit 2510, a camera controller 2514, and a display controller 2512. In various embodiments, the control circuit 2502 can interface with an SD card 2516, mass storage 2518, and system memory 2520. In various embodiments, the control circuit 2502 can interface with universal integrated circuit card (UICC) 2522. A spatial location determining circuit can be included and can take the form of an integrated circuit 2524 that can include components for receiving signals from GPS, GLONASS, BeiDou, Galileo, SBAS, WLAN, BT, FM, NFC type protocols, 5G picocells, or E911. In various embodiments, the accessory device can include a camera 2526. In various embodiments, the control circuit 2502 can interface with a primary display 2528 that can also include a touch screen 2530. In various embodiments, an audio I/O circuit 2538 can interface with the control circuit 2502 as well as a microphone 2542 and a speaker 2540. In various embodiments, a power supply circuit 2536 can interface with the control circuit 2502 and/or various other circuits herein in order to provide power to the system. In various embodiments, a communications circuit 2534 can be in communication with the control circuit 2502 as well as one or more antennas (2544, 2546).

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A method executed in a processor of an ear-wearable device system for providing information related to an ear-wearable device system, a user of an ear-wearable device system, or a communication partner of the user, the ear-wearable device system further comprising an ear-wearable device, an accessory speaker outside of an ear-wearable device housing, and an accessory microphone, wherein the ear-wearable device comprises an ear-wearable device speaker, an ear-wearable device microphone, and a memory storage, the method comprising:
recording a first audio sample with the ear-wearable device microphone, wherein the first audio sample comprises a first target stimuli;
recording a second audio sample with the accessory microphone, wherein the second audio sample comprises a second target stimuli; and
playing the first audio sample and the second audio sample at the accessory speaker or at the ear-wearable device speaker.

2. The method of claim 1, wherein the first audio sample and the second audio sample are recorded simultaneously.

3. The method of claim 2, wherein the first target stimuli and the second target stimuli are the same stimuli.

4. The method of claim 3, further comprising synchronizing the first audio sample and the second audio sample to create a composite audio sample, and playing the first audio sample and the composite audio sample at the accessory speaker or at the ear-wearable device speaker.

5. The method of claim 1, further comprising prompting a user input selection of the first audio sample or the second audio sample, wherein the user input selection indicates the audio sample in which the target stimuli is most understandable to the user.

6. The method of claim 1, wherein the accessory microphone is at a first location during the recording of the second audio sample, the method further comprising:
recording a third audio sample with the accessory microphone at a second location different from the first location, wherein the third audio sample comprises a third target stimuli; and
playing the third audio sample at the accessory speaker or at the ear-wearable device speaker; and
prompting a user input selection the first audio sample, the second audio sample, or the third audio sample, wherein the user input selection indicates the audio sample in which the target stimuli is most understandable.

7. The method of claim 1, wherein the accessory microphone is facing a first direction during the recording of the second audio sample, the method further comprising:
recording a third audio sample with the accessory microphone facing a second direction different from the first direction, wherein the third audio sample comprises a third target stimuli; and
playing the third audio sample at the accessory speaker or at the ear-wearable device speaker; and
prompting a user input selection the first audio sample, the second audio sample, or the third audio sample, wherein the user input selection indicates the audio sample in which the target stimuli is most understandable.

8. The method of claim 1, further comprising generating an extraneous sound originating at a second location during the recording of the audio samples.

9. The method of claim 8, wherein the accessory microphone is at a first location during the recording of the second audio sample, the method further comprising:
recording a third audio sample with the accessory microphone at a third location different from the first location, wherein the third location is further away from the second location than the first location, and wherein the third audio sample comprises a third target stimuli; and
playing the third audio sample at the accessory speaker or at the ear-wearable device speaker; and
prompting a user input selection the first audio sample, the second audio sample, or the third audio sample, wherein the user input selection indicates the audio sample in which the target stimuli is most understandable.

10. The method of claim 1, wherein the accessory microphone is using a first set of processing parameters during the recording of the second audio sample, the method further comprising:
recording a third audio sample with the accessory microphone using a second set of processing parameters different from the first set of processing parameters, wherein the third audio sample comprises a third target stimuli; and
playing the third audio sample at the accessory speaker or at the ear-wearable device speaker; and
prompting a user input selection of the first audio sample, the second audio sample, or the third audio sample, wherein the user input selection indicates the audio sample in which the target stimuli is most understandable.

11. The method of claim 1, wherein the ear-wearable device system further comprises a display device configured to display a visual representation of the first audio sample and the second audio sample.

12. The method of claim 11, the method further comprising prompting a user input selection of the first audio sample or the second audio sample, wherein the user input selection indicates the audio sample in which the target stimuli is most understandable on the display device.

13. The method of claim 1, the first target stimuli and the second target stimuli comprising voice signals, the method further comprising prompting a user input selection of the first audio sample or the second audio sample, wherein the user input selection indicates the audio sample in which the voice signals are most understandable.

14. The method of claim 1, wherein the ear-wearable device microphone is a directional microphone configured to have a beam in front of the user and null being at an angle relative to the front of the user when the ear-wearable device is worn by the user.

15. The method of claim 1, the accessory microphone comprising an array of microphones.

16. A method executed in a processor of an ear-wearable device system for providing information related to an ear-wearable device system, a user of an ear-wearable device system, or a communication partner of the user, the ear-wearable device system further comprising an ear-wearable device, an accessory speaker outside of an ear-wearable device housing, and an accessory microphone, wherein the ear-wearable device comprises an ear-wearable device speaker, an ear-wearable device microphone, and a memory storage, the method comprising:
recording a first audio sample with the ear-wearable device microphone, wherein the first audio sample comprises a first target stimuli;
recording a second audio sample with both the accessory microphone and the ear-wearable device microphone, wherein the second audio sample comprises a second target stimuli;
synchronizing the second audio sample recorded with the accessory microphone with the second audio sample recorded with the ear-wearable device microphone to create a composite audio sample; and
playing the first audio sample and the composite audio sample at the accessory speaker or at the ear-wearable device speaker.

17. The method of claim 16, further comprising prompting a user input selection of the first audio sample or the composite audio sample, wherein the user input selection indicates the audio sample in which the target stimuli is most understandable.

18. The method of claim 16, wherein the ear-wearable device system further comprises a display device configured to display a visual representation of the first audio sample and the composite audio sample.

19. The method of claim 18, the method further comprising prompting a user input selection of the first audio sample or the composite audio sample, wherein the user input selection indicates the audio sample in which the target stimuli is most understandable on the display device.

20. The method of claim 16, the first target stimuli and the second target stimuli comprising voice signals, the method further comprising prompting a user input selection of the first audio sample or the composite audio sample, wherein the user input selection indicates the audio sample in which the voice signals are most understandable.
